(19) United States
(12) Patent Application Publication
(10) Pub. No.: US 2013/0058627 A1
(43) Pub. Date: Mar. 7, 2013

(54) INFORMATION PROCESSING DEVICE, INFORMATION PROCESSING METHOD, AND PROGRAM

(71) Applicants: Kae Nagano, Tokyo (JP); Tomizo Shiraishi, Kanagawa (JP); Ryohei Takahashi, Kanagawa (JP); Takeshi Takeuchi, Tokyo (JP); Minako Takahashi, Tokyo (JP)

(72) Inventors: Kae Nagano, Tokyo (JP); Tomizo Shiraishi, Kanagawa (JP); Ryohei Takahashi, Kanagawa (JP); Takeshi Takeuchi, Tokyo (JP); Minako Takahashi, Tokyo (JP)

(73) Assignee: SONY CORPORATION, Tokyo (JP)

(21) Appl. No.: 13/594,061

(22) Filed: Aug. 24, 2012

(30) Foreign Application Priority Data
Sep. 2, 2011 (JP) 2011-191787

(51) Int. Cl. H04N 9/80

(52) U.S. Cl. 386/241; 386/E09.045

(57) ABSTRACT

Provided is an information processing device including a data processing unit for performing a process of reproducing content including music content. The data processing unit performs the content reproduction process using a scenario in which reproduction control information is recorded and a playlist file including designation information on the content to be reproduced, the playlist file has playitem information including the designation information on a stream file in which the content as reproduction target data is stored, and position information corresponding to an entry mark corresponding to a boundary position between each playitem and a link point set within a reproduction section of each playitem, the scenario has control information for a scene that is a content portion divided by the entry mark and the link point, and the data processing unit performs the reproduction control, performs transitioning of the scene to be reproduced and switching of the control information.

### CROSS-REFERENCE TO RELATED APPLICATION

The present application claims priority from Japanese Patent Application No. JP 2011-191787 filed in the Japanese Patent Office on Sep. 2, 2011, the entire content of which is incorporated herein by reference.

### BACKGROUND

The present disclosure relates to an information processing device, an information processing method, and a program, and more particularly, to an information processing device, an information processing method, and a program that perform music reproduction.

Many compact discs (CDs), for example, are used as recording media of music content. In addition, using media having a high capacity such as Digital Versatile Discs (DVDs), Blu-ray Disc (BDs) (registered trademark), or flash memories has recently been considered.

However, it is necessary to perform recording and reproduction on media such as a CD, a DVD, a BD, and so forth in accordance with the respective standards. For example, in a case of the CD, reproduction control is set to be easily performed in consideration of convenience at the time of music reproduction. For example, a reproduction process for each piece of music such as a process of searching for beginnings of a plurality of pieces of music from the CD on which the plurality of pieces of music are recorded and then reproducing any piece of music, a process of repeatedly reproducing one piece of music, and so forth may be easily performed.

Meanwhile, for example, in the DVD or the BD on which image data such as movies is mostly recorded, reproduction control on the image reproduction having high availability such as fast reproduction and slow reproduction, in particular, more convenient reproduction control in the image reproduction, is set to be easily performed.

For example, in the related art of image reproduction control on DVDs, Japanese Patent Registration No. 3154703, Japanese Patent Registration No. 3128220, Japanese Patent Registration No. 3617201, and so forth are disclosed.

Japanese Patent Registration No. 3154703 and Japanese Patent Registration No. 3128220 disclose configurations in which the image reproduction can be performed from various reproduction positions.

Japanese Patent Registration No. 3617201 discloses the configuration in which a reproduction process of setting an arbitrary reproduction sequence with a plurality of image data combined is performed.

All of the related arts mentioned above disclose the control configuration in which one image scene is transitioned to a next image scene.

However, in general, at the time of switching a reproduction image position such as switching the scene, a black image is displayed on a display unit and a pause occurs on an output image. This is, for example, because it is necessary to take time to switch a playlist file including reproduction control information, and so forth. The pause time occurring on the image depends on a processing capacity of a reproduction device.

However, for example, when a plurality of pieces of music are continuously reproduced, a user may often feel displeasure when the pause time (a silence time) that differs depending on reproduction equipment occurs between any one piece of music and the next music.

In general, in the CD or the like on which a plurality of pieces of music are recorded, there are many cases in which intervals between pieces of music are set as time intervals according to the demands of respective artists.

When these time intervals between pieces of music are changed in accordance with circumstances of control times of reproduction equipment, the user may feel displeasure, and the value of the music content itself may also be degraded.

However, for example, when the process of reproducing many contents on the DVD or BD is performed, it is necessary to perform the process using many files such as a playlist as reproduction control information, clip information designated by the playlist, a content file (AV stream file) associated with the clip information, and so forth. Since the time is taken to read or switch these files, a processing delay may easily occur.

In particular, when the music content is reproduced using reproduction equipment having a low processing capacity, much time is taken to switch the file in accordance with the change in the piece of music, and the silence time between pieces of music is highly likely to be excessive.

### SUMMARY

The present disclosure is made, for example, in consideration of the problems described above and to provide an information processing device, an information processing method, and a program that enable music reproduction without changing a predetermined time interval between pieces of music or enable smooth reproduction from a designated position to be performed with a configuration in which the music reproduction process is performed using playlists as reproduction control information files on the BD or the like.

According to a first embodiment of the present disclosure, there is provided an information processing device, including a data processing unit configured to perform a process of reproducing content including music content. The data processing unit performs the content reproduction process using a scenario in which reproduction control information is recorded and a playlist file including designation information on the content to be reproduced, the playlist file has playitem information including the designation information on a stream file in which the content as reproduction target data is stored, and position information corresponding to an entry mark corresponding to a boundary position between each playitem and a link point set within a reproduction section of each playitem, the scenario has control information for a scene that is a content portion divided by the entry mark and the link point, and the data processing unit performs the reproduction control in accordance with the control information for the scene of the scenario, performs transitioning of the scene to be reproduced and switching of the control information for the scene of the scenario on the basis of the entry mark and the link point.

According to an embodiment of the present disclosure, the entry mark is set as a start position of at least one piece of music or a start position of a standby screen, the link point is set as a position at least within a piece of music, the scene is divided by the entry mark and the link point, and a plurality of scenes are set for one piece of music, and the data processing unit performs different control depending on the scene to be reproduced even in a reproduction period of the same piece of music in accordance with the scenario having the control information different depending on each scene.

According to an embodiment of the present disclosure, the scenario has instruction information on a transition destination scene according to an input of a next piece reproduction (Next) instruction or a previous piece reproduction (Prey) instruction in a reproduction period of each scene as the control information for each scene, and the data processing unit performs determination on a different transition destination depending on the scene to which a next piece reproduction (Next) instruction or a previous piece reproduction (Prev) instruction is input even during reproduction of the same piece of music in accordance with the control information for each scene of the scenario.

According to an embodiment of the present disclosure, the scenario has instruction information on a transition destination scene according to an input of a fast-forward (FF) instruction or a rewind (REW) instruction in a reproduction period of each scene as the control information for each scene, and the data processing unit performs determination on a different transition destination depending on the scene to which a fast-forward (FF) instruction or a rewind (REW) instruction are input even during reproduction of the same piece of music in accordance with the control information for each scene of the scenario.

According to an embodiment of the present disclosure, the scenario has the control information according to repeat reproduction settings including a repeat reproduction setting for all pieces of music, a repeat reproduction setting for one piece of music, and a no repeat reproduction setting as the control information for each scene, and the data processing unit performs the reproduction control according to the repeat reproduction setting in accordance with the control information for each scene of the scenario, detects an end of a piece of music to be repeatedly reproduced in the repeat reproduction setting for all pieces of music or the repeat reproduction setting for one piece of music on the basis of the link point of a silence section position that is a scene boundary, and performs control of transitioning to a start position of the repeat reproduction.

According to an embodiment of the present disclosure, the scenario has at least any one of remote controller operation information, control information according to menu screen operation information, or control information relating to scene transitioning by virtue of program reproduction as the control information for each scene, and the data processing unit performs transition destination control in accordance with the control information for each scene of the scenario.

According to an embodiment of the present disclosure, the link point is set as a position immediately after start of each piece of music, and the scene is divided by the set position of the link point, the scenario having the control information for the scene sets a reproduction control mode of a scene immediately after the start of each piece of music and a reproduction control mode of a scene after the scene immediately after the start of each piece of music to be different from each other, and the data processing unit performs different reproduction control depending on each scene.

According to an embodiment of the present disclosure, the link point is set as a boundary position between an end position of each piece of music and a silence section up to a next piece of music, and a scene is divided by the set position of the link point, the scenario having the control information for the scene sets a reproduction control mode of a scene up to an end of each piece of music and a reproduction control mode of a scene in a silence section immediately after the end of each piece of music to be different from each other, and the data processing unit performs different reproduction control depending on each scene.

According to a second embodiment of the present disclosure, there is provided an information recording medium, including a stream file in which content including music content is stored, a scenario in which reproduction control information on the content is recorded, and a playlist file including designation information on the content to be reproduced. The playlist file has playitem information including the designation information on a stream file in which the content as reproduction target data is stored, and position information corresponding to an entry mark corresponding to a boundary position between each playitem and a link point set within a reproduction section of each playitem, the scenario has control information for a scene that is a content portion divided by the entry mark and the link point, and the information recording medium allows a reproduction device reproducing the content to perform the reproduction control in accordance with the control information for each scene of the scenario, to perform transitioning of the scene to be reproduced and switching of the control information for the scene of the scenario on the basis of the entry mark and the link point.

According to a third embodiment of the present disclosure, there is provided an information processing method performed by an information processing device having a data processing unit configured to perform a process of reproducing content including music content, the information processing method including performing, by the data processing unit, the content reproduction process using a scenario in which reproduction control information is recorded and a playlist file including designation information on the content to be reproduced. The playlist file has playitem information including the designation information on a stream file in which the content as reproduction target data is stored, and position information corresponding to an entry mark corresponding to a boundary position between each playitem and a link point set within a reproduction section of each playitem, the scenario has control information for a scene that is a content portion divided by the entry mark and the link point, and the step of performing includes performing the reproduction control in accordance with the control information for each scene of the scenario, transitioning of the scene to be reproduced, and switching of the control information for each scene of the scenario on the basis of the entry mark and the link point.

According to a fourth embodiment of the present disclosure, there is provided a program causing an information processing device to perform a process of reproducing content, the information processing device having a data processing unit configured to perform the process of reproducing content including music content, the program causing the data processing unit to perform performing the content reproduction process using a scenario in which reproduction control information is recorded and a playlist file including designation information on the content to be reproduced. The playlist file has playitem information including the designation information on a stream file in which the content as reproduction target data is stored, and position information corresponding to an entry mark corresponding to a boundary position between each playitem and a link point set within a reproduction section of each playitem, the scenario has control information for a scene that is a content portion divided by the entry mark and the link point, and the step of performing includes performing the reproduction control in accordance with the control information for each scene of the scenario, transitioning of the scene to be reproduced, and switching of the control information for each scene of the scenario on the basis of the entry mark and the link point.

Note that the program of the present disclosure is a program that can be provided in a storage medium or communication medium that is provided in a computer-readable form for an information processing device or a computer system that is capable of executing various types of program code, for example. Providing this sort of program in a computer-readable form makes it possible to implement, the processing according to the program in the information processing device or the computer system.

The purposes, features, and advantages of the present disclosure will be made clear later by a more detailed explanation that is based on the embodiments of the present disclosure and the appended drawings. Furthermore, the system in this specification is not limited to being a configuration that logically aggregates a plurality of devices, all of which are contained within the same housing.

According to an embodiment of the present disclosure described above, a device and method by which the smooth reproduction control on the music content can be performed are realized.

In particular, the content reproduction process is performed using the scenario in which the reproduction control information is recorded and the playlist file including the designation information on the content to be reproduced. The playlist file has playitem information including the designation information on the stream file in which the content is stored as the reproduction target data, and position information corresponding to the entry mark for the boundary position of each playitem and the link point set within the reproduction section of each playitem. The scenario has the control information for the scene that is a content portion divided by the entry mark and the link point. The data processing unit of the information processing device performing the content reproduction performs the reproduction control in accordance with the control information for the scene of the scenario, and performs transitioning of the scene to be reproduced and switching of the control information for the scene of the scenario on the basis of the entry mark and the link point.

According to these configurations, a device and method by which the smooth reproduction control on the music content can be performed are realized.

### BRIEF DESCRIPTION OF THE DRAWINGS

FIG. 1 is a diagram illustrating an outline of a content reproduction process using an information processing device;

FIG. 2 is a diagram illustrating an example of an image displayed on an information processing device or an output unit at the time of music reproduction in an information processing device;

FIG. 3 is a sequence diagram illustrating data stored on an information recording medium (BD);

FIG. 4 is a diagram illustrating an outline of a music reproduction process using a reproduction control program (BD-J) and a scenario included in a JAR file, and a playlist file;

FIG. 5 is a diagram illustrating a configuration example of a playlist applied to a music reproduction process;

FIG. 6 is a diagram illustrating a music reproduction process to which a scenario is applied;

FIG. 7 is a diagram illustrating a music reproduction process to which a scenario is applied;

FIG. 8 is a diagram illustrating a music reproduction process to which a scenario is applied;

FIG. 9 is a diagram illustrating an example of setting a playlist file and a stream file;

FIG. 10 is a diagram illustrating an example of setting a playlist and a stream file;

FIG. 11 is a diagram illustrating a specific example of a scenario recorded as XML data and a reproduction process;

FIG. 12 is a diagram illustrating a specific example of a scenario recorded as XML data and a reproduction process;

FIG. 13 is a diagram illustrating a specific example of a scenario recorded as XML data and a reproduction process;

FIG. 14 is a diagram illustrating a specific example of a scenario recorded as XML data and a reproduction process;

FIG. 15 is a diagram illustrating a specific example of a scenario recorded as XML data and a reproduction process;

FIG. 16 is a flowchart illustrating an example of a reproduction control process sequence in accordance with a scenario description;

FIG. 17 is a flowchart illustrating an example of sequences of a reproduction control process in accordance with a scenario description;

FIG. 18 is a diagram illustrating an example of a hardware configuration of an information processing device performing content reproduction in accordance with a scenario;

FIG. 19 is a flowchart illustrating an entire sequence of a content reproduction process performed by an information processing device; and

FIG. 20 is a diagram illustrating a configuration example of a content editing device.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, an information processing device, an information processing method, and a program of the present disclosure will be described with reference to the drawings. In addition, the description is made in the following order:

1. Outline of content reproduction process using information processing device

2. Outline of reproduction control process and data stored in information recording medium

3. Example of music reproduction process to which scenario is applied

4. Other example of setting playlist and stream file

5. Specific examples of scenario recorded as XML data and reproduction process examples
5-1. Description of scenario for scene 00 and process according to scenario
5-2. Description of scenario for scene 01 and process according to scenario
5-3. Description of scenario for scene 02 and process according to scenario
5-4. Description of scenario for scene 12 and process according to scenario
5-5. Description of scenario for scene 13 and process according to scenario
5-6. Description of scenario for scene 14 and process according to scenario
5-7. Description of scenarios for scenes 15 to 17 and processes according to scenarios

6. Flow of reproduction control process according to scenario

7. Configuration example of information processing device

8. Content reproduction process sequence of information processing device

9. Configuration example of content editing device

10. Summary of configurations of present disclosure

### [1. Outline of Content Reproduction Process Using Information Processing Device]

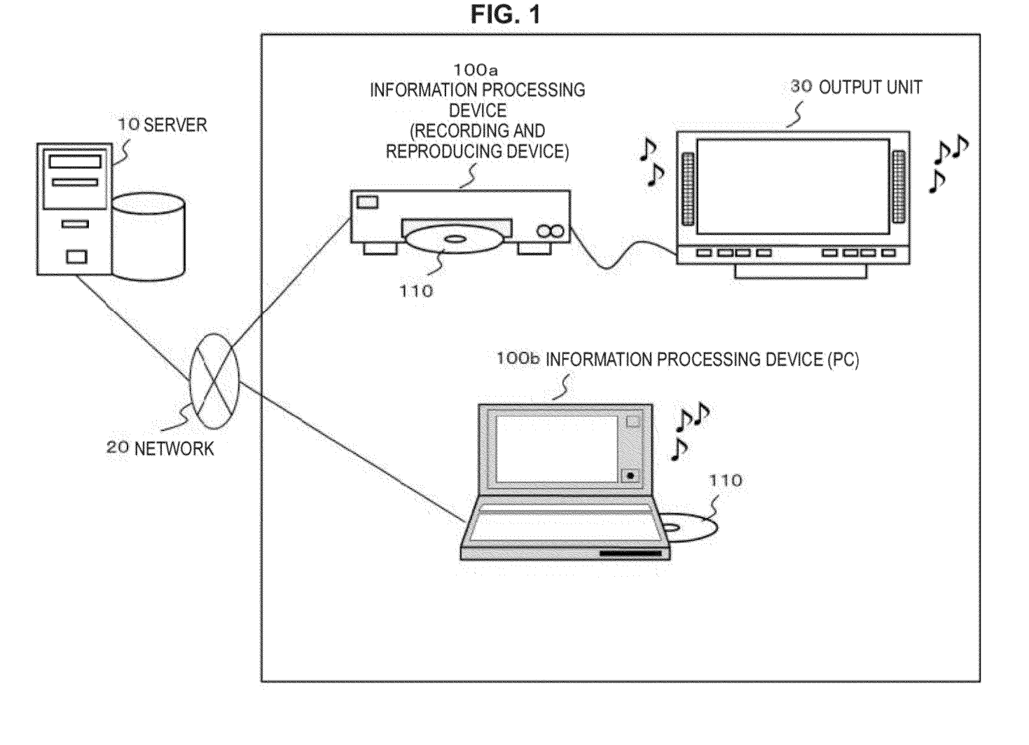

First, an outline of a content reproduction process using an information processing device of the present disclosure will be described with reference to FIG. 1.

For example, the information processing device of the present disclosure is an information recording medium on which music content is recorded, particularly, a device performing music reproduction from the BD.

Referring to FIG. 1, an information processing device 100a acting as a recording and reproducing device such as a BD recorder or a BD player, and an information processing device 100b acting as a personal computer (PC) are illustrated as examples of the information processing device.

The information processing devices 100a and 100b perform music reproduction using an information recording medium (BD) 110 mounted on the devices. In addition, still image or moving image content as well as the music content are recorded on the information recording medium 110, and the still images or the moving images are also reproduced in addition to the music reproduction.

The information processing device 100a, i.e., the recording and reproducing device such as the BD recorder or the BD player, is connected to an output unit 30 having a display and a speaker, and data (audio/image) reproduced from the information recording medium (BD) 110 by the information processing device 100a is output to the output unit 30. In addition, the output unit may be configured as an audio output unit without having the display.

The information processing device 100b, that is, the PC, has a speaker and a display, and data (audio/image) reproduced from the from the information recording medium (BD) 110 by the information processing device 100b is output to the speaker and the display of the PC.

In addition, the information processing devices 100a and 100b are connected to a server 10 via a network 20 while the music is reproduced. The server 10 supplies information relating to the music being reproduced, for example, a message from or recent situation on a singer (artist) (Twitter), various news (RSS) associated with the reproduction music such as a concert, to the information processing devices 100a and 100b. The information processing devices 100a and 100b output and display the information received from the server 10 on a display.

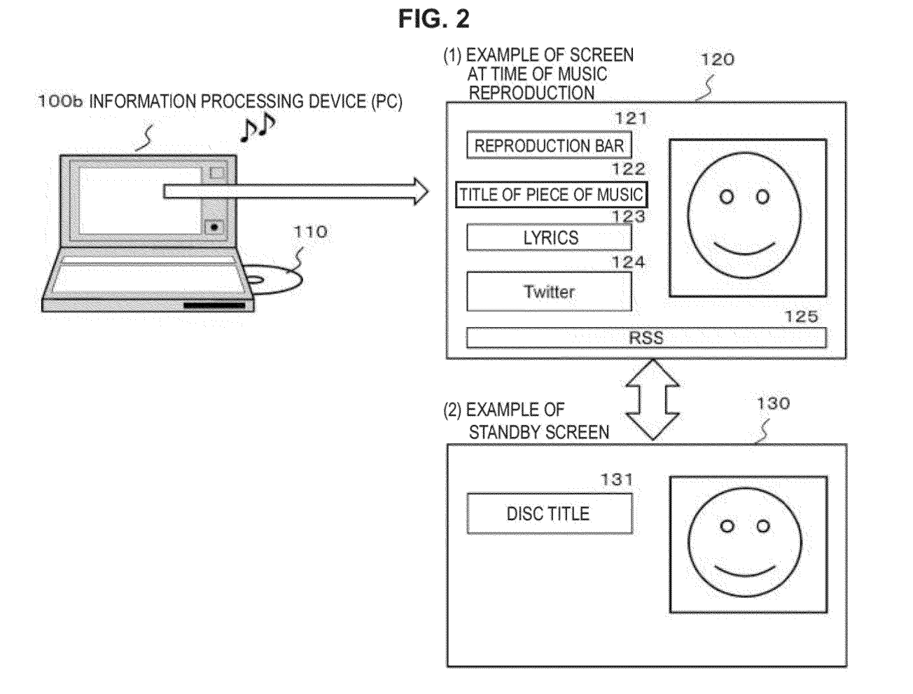

An example of the image displayed on the information processing device or the output unit when the information processing devices 100a and 100b reproduce the music is illustrated in FIG. 2.

Referring to FIG. 2,

(1) an example of a screen 120 at the time of music reproduction, and

(2) an example of a standby screen 130 are illustrated as examples of two types of display data.

When the information recording medium (BD) 110 is mounted on the information processing devices 100a and 100b, music reproduction is then initiated. For example, when the information recording medium (BD) 110 on which a plurality of pieces of music are recorded is mounted on the information processing devices 100a and 100b, music reproduction is initiated from the first piece of music.

In addition, this reproduction control process is performed in accordance with a reproduction control program recorded on the information recording medium (BD) 110. Details of the reproduction process will be described later.

For example, in a period during which the music is being reproduced, for example, a still image screen represented as (1) of FIG. 2 that is an example of the screen 120 at the time of music reproduction is displayed.

For example, a reproduction bar 121 is an area indicating approximate reproduction position information on one music piece. The music indicates one piece of music.

The title 122 of the piece of music is an area indicating a title of the music being reproduced.

The lyrics 123 are an area indicating lyrics of the music being reproduced.

Twitter 124 is an area, for example, indicating a message or the like from a singer (artist) of the music being reproduced.

The RSS 125 is an area indicating various news information relating to the reproduction music such as a recent situation or a concert.

Twitter 124 and the RSS 125 are areas, for example, displaying information received from the server 10.

### [2. Outline of Reproduction Control Process and Data Stored in Information Recording Medium]

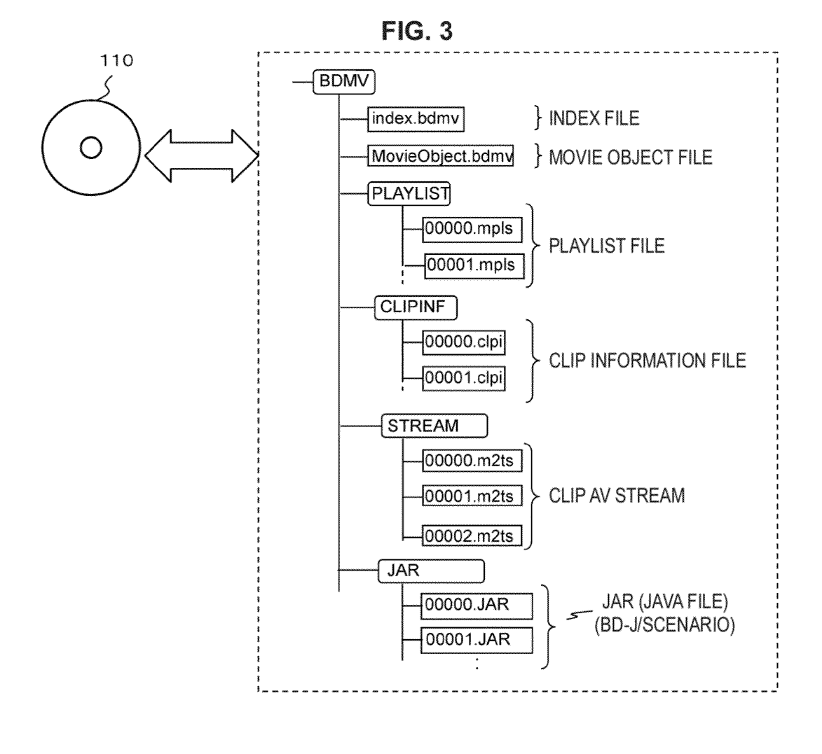

Next, an outline of the reproduction control process and the data stored in the information recording medium BD 110 will be described with reference to FIG. 3.

The directory for the data recorded on the BD has a configuration shown in FIG. 3. As shown in FIG. 3, for example, the following files are recorded in the directory:
index file;
movie object file;
playlist file;
clip information file;
clip AV stream file; and
JAR file.

Title information is stored in the index file as index information to be applied to the reproduction process. For example, the user may designate the title to perform a predetermined content reproduction process.

The movie object file is a moving image reproduction process program to be mostly applied to the moving image reproduction process.

The playlist file is a file in which a reproduction order of content or the like is designated in accordance with program information on the reproduction program designated by the title, and has designation information corresponding to clip information having reproduction position information, and so forth.

The clip information file is a file designated by the playlist file, and has the reproduction position information on the clip AV stream file.

The clip AV stream file is a file in which AV stream data is stored as a reproduction target.

The JAR file is a file in which a BD-compliant JAVA (registered trademark) program (BD-J) and a scenario in which reproduction control information is recorded at the time of music reproduction are stored.

The sequence by which the information processing device reproduces the contents recorded on the information recording medium is as follows:

First, a specific title is designated from the index file by the reproduction application.

A reproduction program associated with the designated title is then selected.

A playlist in which an order of reproducing the contents in accordance with the program information on the selected reproduction program is designated is then selected.

An AV stream is read by the clip information designated by the selected playlist as actual content data, and is then reproduced.

In addition, the music reproduction process that will be described below is performed using the reproduction control program (BD-J) and the scenario stored in the JAR file, the playlist file, and so forth.

The music contents are stored in the clip AV stream file (xxxxx.m2ts) for each piece of music, for example.

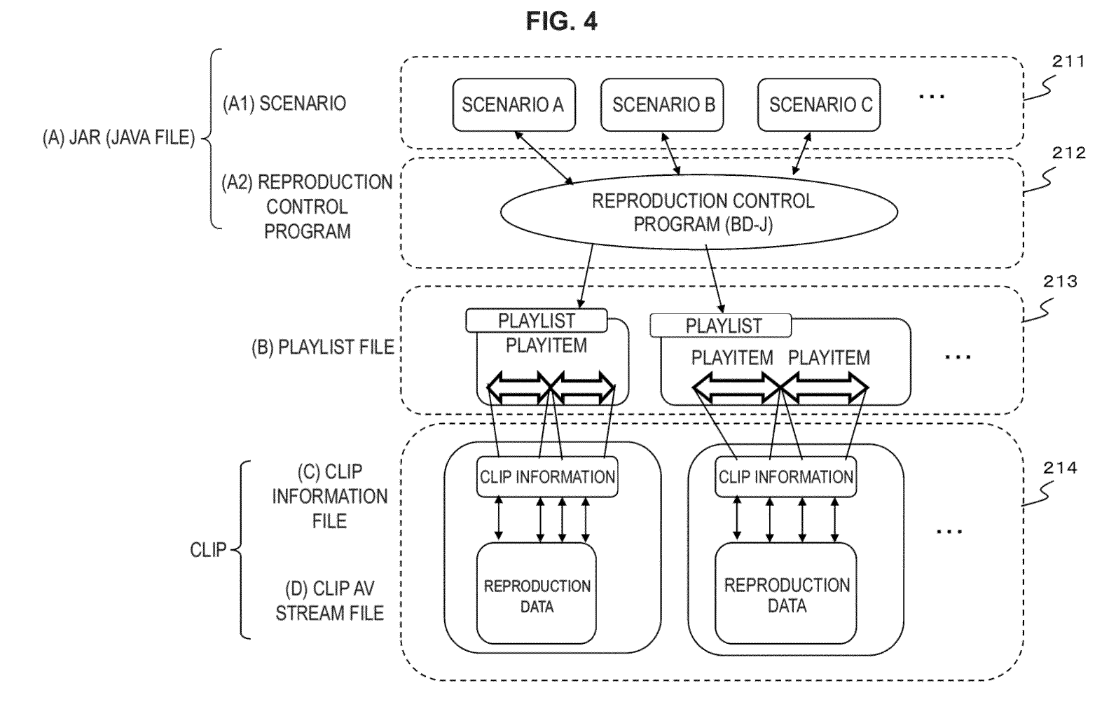

The outline of the music reproduction process using the reproduction control program (BD-J) and the scenario stored in the JAR file and the playlist file will be described referring to FIG. 4.

Referring to FIG. 4, reproduction data (clip AV stream file), which is a music content file recorded on the information recording medium (BD) 110, and data used to control the reproduction of the music content are illustrated. In particular, the following data is illustrated:
(A) JAR (JAVA (registered trademark)) file;
   (A1) scenario 211;
   (A2) reproduction control program (BD-J) 212;
(B) playlist 213;
(C) clip 214;
   (C1) clip information file; and
   (C2) clip AV stream file.

The music content is stored in (C2) the clip AV stream file as the reproduction target. For example, in the case of the BD on which a plurality of pieces of music are recorded, the following clip AV stream files (xxxxx.m2ts) are set as files for the respective pieces of music:

a music file of the first piece of music: 00000.m2ts;

a music file of the second piece of music: 00001.m2ts;

a music file of the third piece of music: 00002.m2ts.

Individual clip information files (xxxxx.clpi) are set in association with the respective music files (xxxxx.m2ts).

The playlist file 213 is a file in which reproduction control information is stored, a clip information file (xxxxx.clpi) associated with the clip AV stream file (xxxxx.m2ts) is acquired as a reproduction target, and the reproduction control on the music content is then performed.

The reproduction control program (BD-J) 212 is a BD-compliant JAVA (registered trademark) program. The reproduction control program (BD-J) 212 uses the scenario 211, the playlist file 213, and so forth to perform the reproduction control on the music content.

The scenario 211 is, for example, data described by the XML data, and describes various reproduction sequences that are difficult to realize only with the playlist, or describes control information according to user instructions while the music is reproduced.

In particular, for example, the scenario 211 is data including specific reproduction control information such as reproduction control information on a repeat reproduction process, and reproduction control information according to user input information such as a next piece reproduction instruction (Next) and a previous piece reproduction instruction (Prev) as input information from the user.

The playitem is included in the playlist as information for designating reproduction target data. Reproduction data, which is actual content data, is selectively read by the clip information as the reproduction section defined by the playitem included in the playlist, and the reproduction process is then performed. In addition, a plurality of the playitems may be set in the playlist.

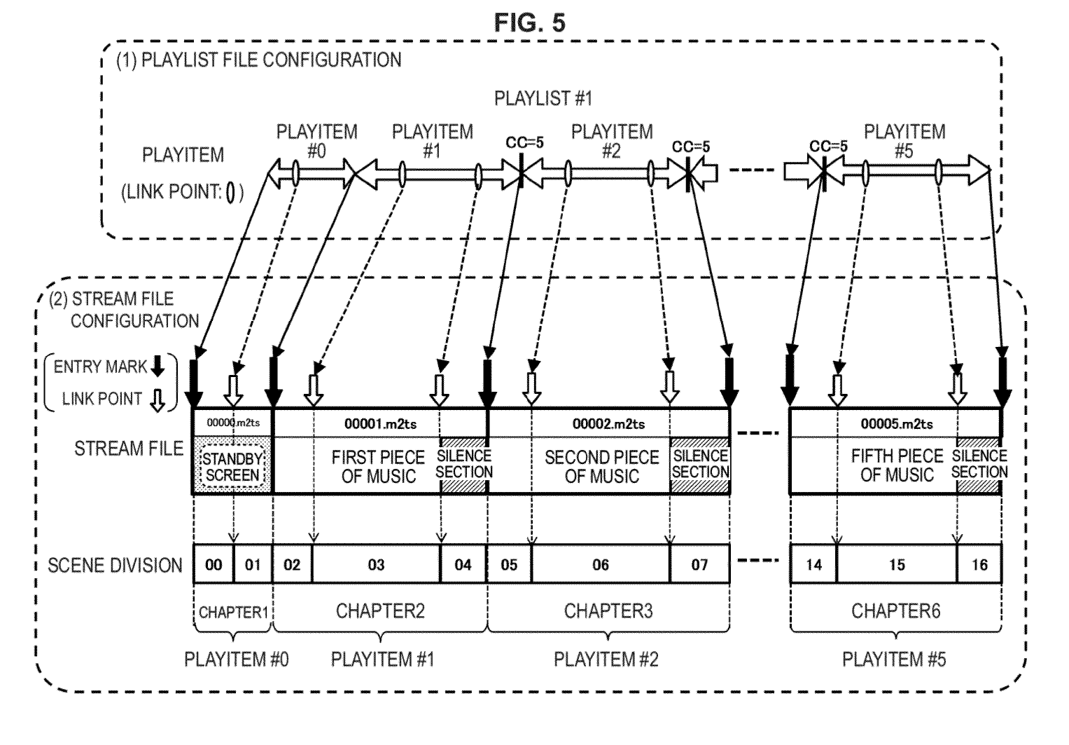

A configuration example of the playlist (playlist for reproducing the music) to be applied to the music reproduction process will be described with reference to FIG. 5.

FIG. 5 illustrates the configuration example of one playlist for reproducing music set as the reproduction control information on five AV stream files (xxxxx.m2ts) that are individually recorded as five music pieces on the information recording medium (BD). The music indicates one piece of music. In addition, hereinafter, the AV stream file is referred to as a “stream file” or a “stream.”

Referring to FIG. 5,

(1) a playlist file (playlist file for reproducing music) configuration, and

(2) a stream file configuration are illustrated.

As shown in (2) the stream file configuration of FIG. 5,

the stream file includes six stream files such as

a stream file (00000.m2ts) corresponding to the standby screen,

a stream file (00001.m2ts) corresponding to the first piece of music,

a stream file (00002.m2ts) corresponding to the second piece of music,

a stream file (00003.m2ts) corresponding to the third piece of music,

a stream file (00004.m2ts) corresponding to the fourth piece of music, and

a stream file (00005.m2ts) corresponding to the fifth piece of music.

In addition, the stream file (00000.m2ts) corresponding to the standby screen includes, for example, image reproduction data corresponding to the standby screen 130 described with reference to FIG. 2.

The stream files (00001.m2ts to 00005.m2ts) corresponding to the first to fifth pieces of music include audio data for respective music pieces and image reproduction data for the screen 120 at the time of music reproduction described with reference to FIG. 2.

As shown in (2) the stream file configuration of FIG. 5, each stream file is divided into one or more scenes.

In the illustrated example,

the stream file (00000.m2ts) corresponding to the standby screen includes scenes 00 and 01, the stream file (00001.m2ts) corresponding to the first piece of music includes scenes 02, 03, and 04, and the stream file (00002.m2ts) corresponding to the second piece of music includes scenes 05, 06, and 07.

In this way, each stream file is configured to include one or more scenes.

The scenes of each piece of music may be variously set. For example, the scenes are set to be divided as follows:

a section up to two seconds from the start position of the piece of music is set as the first scene,

a section from two seconds from the start position of the piece of music until an end of the music piece is set as the second scene, and

a silence section from the end of the piece of music up to the next piece of music is set as the third scene.

In addition, a start point and an end point of each scene are defined by packet identifiers of reproduction data or reproduction time information from a reproduction start position of each stream file, and the position information or information for acquiring the position information is recorded in the playlist file.

As shown in (1) the playlist file configuration of FIG. 5, a plurality of playitems are set in the playlist as designation information on reproduction target data.

In the example illustrated in FIG. 5, six playitems #0 to #5 are set in one playlist file (PlayList #1), and are associated with the respective stream files. That is, the playlist file (PlayList #1) has six playitems #0 to #5 having corresponding relations as follows:

Playitem #0: stream file (00000.m2ts) of the standby screen;

PlayItem #1: stream file (00001.m2ts) of the first piece of music;

PlayItem #2: stream file (00002.m2ts) of the second piece of music;

PlayItem #3: stream file (00003.m2ts) of the third piece of music;

PlayItem #4: stream file (00004.m2ts) of the fourth piece of music; and

PlayItem #5: stream file (00005.m2ts) of the fifth piece of music.

Entry marks (Entry Mark) are recorded on the playitems as reproduction position information corresponding to the reproduction start positions and reproduction end positions of the respective stream files.

Further, link points (Link Point) are recorded as reproduction position information corresponding to scene boundary positions of the respective stream files.

As described above, for example, these reproduction positions are recorded on each piece of playitem information on the playlist file as packet identifiers or reproduction time information.

For example, controlling the reproduction using the reproduction position information enables each piece of music to be reproduced from the head of the piece of music or from the scene boundary.

The playitem, the entry mark, and the link point set in one playlist are provided with continuous sequence numbers. Each entry mark and link point is an entry position for accessing during the reproduction of the stream.

For example, a reproduction order of the playlist is defined by arranging the entry marks in the reproduction order.

When two AV streams are continuously reproduced at the time of reproducing any playlist, since an internal buffer provided in an encoder is likely to overflow, reproduction of the previous stream is typically finished and then reproduction of the next stream is performed. For this reason, the screen is instantly frozen when the stream is switched.

However, “seamless reproduction” by which reproduction is continuously performed over streams becomes possible by performing the process to which the seamless information is applied. In order to create streams over which the seamless reproduction is performed, it is necessary to hold the seamless information including a buffer state or time information when the recording of the previous AV stream is finished and to put the seamless information in an available state.

When one playlist includes a plurality of playitems, a connection condition (CC) to the previous playitem, that is, whether continuous reproduction is possible, is described in the playitem. When the connection to subsequent clip information is continuous such as CC=5, the file name of the subsequent Clip information and the connection condition indicating that the connection is continuous such as CC=5 are described in the clip information.

CC=5 illustrated between the playitems in (1) the playlist file configuration of FIG. 5 indicates that the content is generated under the condition of enabling the seamless reproduction between two playitems to be performed. In particular, for example, the connection condition indicates that a plurality of stream files recorded on the information recording medium (e.g., BD) are set to satisfy the condition for realizing the seamless reproduction such that the streams are arranged to enable the continuous reproduction (seamless reproduction) to be performed.

In addition, as shown in the bottom of (2) the stream file configuration of FIG. 5, a data section of each stream file is defined as a chapter, and one playitem is allocated to each corresponding chapter.

As described with reference to FIG. 4, the reproduction control using the playlist file is performed by the reproduction control program (BD-J) 212 set as the BD-compliant JAVA (registered trademark) program.

The reproduction control program (BD-J) 212 performs the content reproduction control using the playlist file defined by the entry mark and the link point and the scenario 211 described as the XML data that are described with reference to FIG. 5.

[3. Example of Music Reproduction Process to which Scenario is Applied]

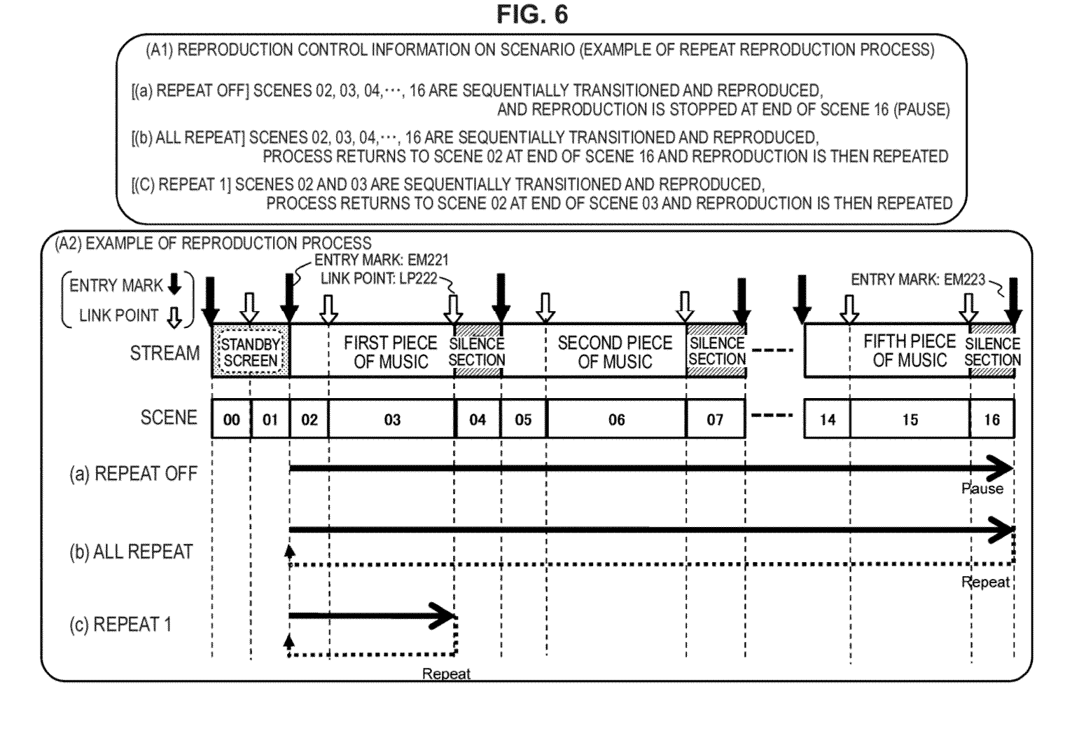

Next, an example of the music reproduction process to which a scenario is applied will be described with reference to FIG. 6 and the subsequent diagrams.

As described above, the scenario is, for example, data described by the XML data, and describes various reproduction sequences that are difficult to realize only with the playlist, or describes control information according to user instructions while the music is reproduced. In particular, for example, the scenario is data including specific reproduction control information such as reproduction control information on a repeat reproduction process, and reproduction control information according to user input information such as a Next instruction and a Prev instruction as input information from the user.

For example, the reproduction control program (BD-J) 212 described with reference to FIG. 4 performs the reproduction control using the scenario 211 and the playlist file 213. The reproduction control information for each scene described with reference to FIG. 5 is recorded in the scenario. For example, as the reproduction control information corresponding to scene xx, control information for the following cases is recorded:

(a) a process when the user input of the Next instruction in the reproduction period of scene xx is detected;

(b) a process when the user input of the Prev instruction in the reproduction period of scene xx is detected;

(c) a process when the reproduction reaches an end position of scene xx in the reproduction period of scene xx including (c1) when all pieces of music are set to be repeated, (c2) when one piece of music is set to be repeated, and (c3) when the repeat reproduction is not set; and

(d) a process when a user input of a fast-forward instruction (FF) is detected in the reproduction period of scene xx.

The reproduction control program (BD-J) 212 applies the data recorded in the scenario, and the entry mark and the link point recorded in the playlist file as reproduction position information in each of the cases mentioned above to perform content reproduction controls according to the description of the scenario, for example, various reproduction controls such as changing the piece of music being reproduced, repeat reproduction, ending the reproduction, and displaying the standby screen.

Hereinafter, the reproduction control process according to various reproduction control information recorded in the scenario will be described with reference to FIGS. 6 to 8.

Each of the control embodiments will be described as below:

(A) an example of a repeat reproduction process (FIG. 6);

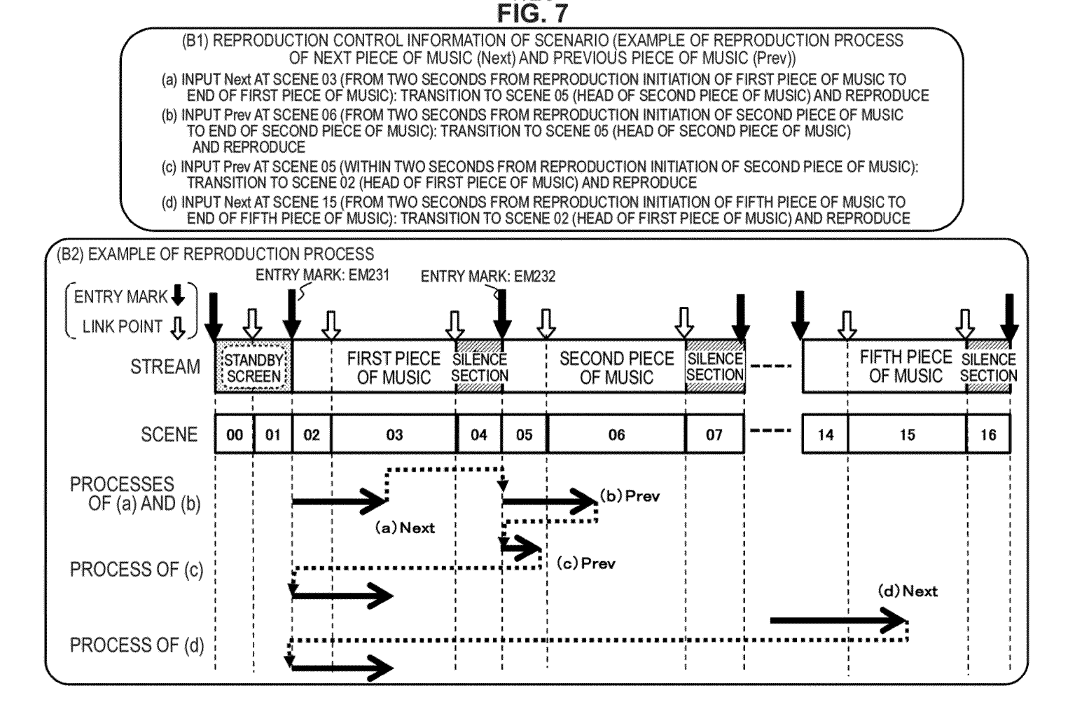

(B) an example of a reproduction control process corresponding to Next instruction and Prey instruction input detection (FIG. 7); and

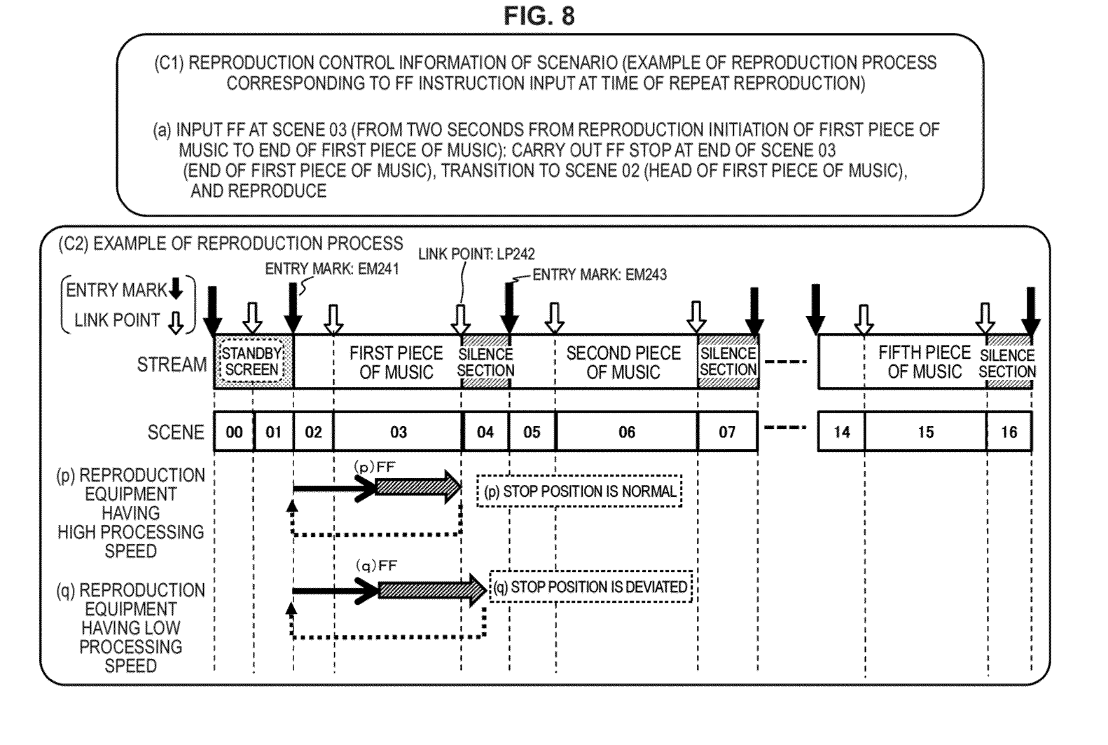

(C) an example of a reproduction control process corresponding to FF input detection at the time of repeat reproduction (FIG. 8).

### (3-1. Example of Repeat Reproduction Process)

First, the example of the repeat reproduction process will be described with reference to FIG. 6.

Referring to FIG. 6,

(A1) reproduction control information on the scenario, and

(A2) an example of the reproduction process are illustrated.

In addition, (A1) reproduction control information on the scenario is actually recorded as the XML data, for example. The “reproduction control information on the scenario” shown in (A1) of FIG. 6 is descriptive text by which the XML data is interpreted and described.

As shown in FIG. 6, (A1) reproduction control information on the scenario at the time of repeat reproduction includes the following information:

(a) reproduction control information when the repeat-off (no repeat reproduction) is set: scenes 02, 03, 04, . . . , 16 are sequentially transitioned and reproduced, and the reproduction is stopped at the final scene 16 (pause);

(b) reproduction control information when the all-repeat (repeat reproduction of all pieces of music) is set: scenes 02, 03, 04, . . . , 16 are sequentially transitioned and reproduced, and the process returns to scene 02 at the end of scene 16 and reproduction is then repeated; and

(c) reproduction control information when repeat 1 is set (repeat reproduction of one piece of music): scenes 02 and 03 are sequentially transitioned and reproduced, and the reproduction returns to scene 02 at the end of scene 03 and is then repeated.

For example, as mentioned in (a) to (c) above, control information for each scene is recorded as XML data in the scenario.

The reproduction control program (BD-J) 212 shown in FIG. 4 applies the entry mark and the link point recorded in the playlist to perform the reproduction control on the basis of the control information for the scene recorded in the scenario 211.

The example of the reproduction process of (A2) of FIG. 6 includes examples of the reproduction process for the scenarios (a) to (c) mentioned above.

### (A) Case of Repeat Off (No Repeat Reproduction)

As shown in (a) of (A2) in FIG. 6, in the case of the repeat off, scenes 03, 04, . . . , are sequentially and continuously reproduced from the initial scene 02 of the first piece of music, and a pause (temporary stop) is made at the time that reproduction reaches the end of scene 16, which is the scene corresponding to the silence section after reproduction of the final fifth piece of music is finished.

The reproduction control program (BD-J) 212 performs these processes in accordance with data recorded in the scenario. The reproduction control program (BD-J) 212 may find the exact reproduction start position or the reproduction stop position by referring to the entry mark and the link point recorded in the playlist file to perform the reproduction control.

In particular, the reproduction control program (BD-J) 212 acquires the reproduction start position corresponding to the entry mark: EM221 shown in (A2) of FIG. 6 from the playlist file, and initiates reproduction from the first piece of music. Further, the reproduction control program performs the content reproduction control by referring to control information for scenes 02 to 16 of the scenario.

Further, the reproduction control program acquires the position of the entry mark: EM223 shown in (A2) of FIG. 6 corresponding to the end position of scene 16 recorded in the scenario as the reproduction stop position at the time of repeat off (no repeat reproduction) from the playlist file, and transitions to the pause process (temporary stop) when it detects that the reproduction position reaches the position of the entry mark: EM223.

### (B) Case of all Repeat (Repeat Reproduction of all Pieces of Music)

In the case of all repeat (repeat reproduction of all pieces of music), scenes 03, 04, . . . are sequentially reproduced from the first scene 02 of the first piece of music, and the process returns to the first scene 02 of the first piece of music and repeats reproduction at the time that reproduction reaches the end of scene 16, which is the scene corresponding to the silence section after reproduction of the final fifth piece of music is finished.

The reproduction control program (BD-J) 212 performs these processes in accordance with the data recorded in the scenario. The reproduction control program (BD-J) 212 may perform control by referring to the entry mark and the link point recorded in the playlist file and finding the exact reproduction start position, the stop position, and the start position of the repeat reproduction.

In particular, the reproduction control program (BD-J) 212 acquires the reproduction start position corresponding to the entry mark: EM221 shown in (A2) of FIG. 6 from the playlist file, and initiates the reproduction from the first piece of music. Further, the reproduction control program performs the content reproduction control by referring to the control information for scenes 02 to 16 of the scenario, detects that reproduction reaches the reproduction stop position corresponding to the entry mark: EM223 shown in (A2) of FIG. 6, and then stops the reproduction. Further, the reproduction control program acquires the position of the entry mark: EM221 shown in (A2) of FIG. 6 corresponding to the start position of scene 02 recorded in the scenario as reproduction start position information for all pieces of music from the playlist file in accordance with the reproduction setting information for all pieces of music, and returns to the first scene 02 of the first piece of music and repeats reproduction.

(C) Case of Repeat 1 (Repeat Reproduction of One Piece of music)

In the case of the repeat 1 (repeat reproduction of one piece of music), the reproduction control program sequentially transitions to scene 03 from the first scene 02 of the first piece of music to perform reproduction, and returns to scene 02 and repeats the reproduction at the end of scene 03 corresponding to the end position of the first piece of music.

The reproduction control program (BD-J) 212 performs these processes in accordance with the data recorded in the scenario. The reproduction control program (BD-J) 212 may perform the control by referring to the entry mark and the link point recorded in the playlist file and finding the exact reproduction start position, the stop position, and the start position of the repeat reproduction.

In particular, the reproduction control program (BD-J) 212 acquires the reproduction start position corresponding to the entry mark: EM221 shown in (A2) of FIG. 6 from the playlist file, and initiates the reproduction from the first piece of music. Further, the reproduction control program performs the content reproduction control by referring to the control information for scenes 02 to 016 of the scenario, detects that the reproduction reaches the reproduction stop position corresponding to the link point: LP222 shown in (A2) of FIG. 6, and stops the reproduction. Further, the reproduction control program acquires the position of the entry mark: EM221 shown in (A2) of FIG. 6 corresponding to the start position of scene 02 recorded in the scenario as the repeat reproduction start position information for one piece of music from the playlist file, returns to the first scene 02 of the first piece of music, and repeats the reproduction in accordance with the repeat reproduction setting information for one piece of music.

### (3-2. Example of Reproduction Control Process Corresponding to Input Detection of Next Instruction and a Prev Instruction)

Next, an example of the reproduction control process corresponding to detection of user inputs such as the Next instruction and the Prev instruction will be described with reference to FIG. 7.

Referring to FIG. 7,

(B1) reproduction control information on a scenario, and

(B2) an example of reproduction process are illustrated in a similar way to FIG. 6.

In addition, for example, (B1) reproduction control information on a scenario is actually recorded as XML data.

The “reproduction control information on a scenario” shown in (B1) of FIG. 7 is descriptive text by which the XML data is interpreted and described.

As shown in (B1) of FIG. 7, (B1) reproduction control information on a scenario corresponding to detection of user inputs such as the Next instruction and the Prev instruction includes the following information:

(a) reproduction control information when an input of a Next instruction is detected in scene 03 (from two seconds from the reproduction start of the first piece of music to the end of first piece of music): the process transitions to scene 05 (head of the second piece of music) and performs reproduction;

(b) reproduction control information when an input of a Prev instruction is detected in scene 06 (from two seconds from the reproduction start of the second piece of music to the end of second piece of music): the process transitions to scene 05 (head of the second piece of music) and performs reproduction;

(c) reproduction control information when an input of a Prev instruction is detected in scene 05 (within two seconds from the reproduction start of the second piece of music): the process transitions to scene 02 (head of the first piece of music) and performs reproduction; and

(d) reproduction control information when an input of a Next instruction is detected in scene 15 (from two seconds from the reproduction start of the fifth piece of music to the end of fifth piece of music): the process transitions to scene 02 (head of the first piece of music) and performs reproduction.

For example, the control information for each scene such as the information (a) to (d) described above is recorded as the XML data in the scenario.

The reproduction control program (BD-J) 212 shown in FIG. 4 applies the entry mark and the link point recorded in the playlist to perform the reproduction control on the basis of this control information for each scene recorded in the scenario 211.

Examples of reproduction process of (B2) of FIG. 7 illustrate reproduction processes corresponding to scenarios (a) to (d) described above.

(a) A case in which an input of a Next instruction is detected in scene 03 (from two seconds from the reproduction start of the first piece of music to the end of first piece of music)

As shown in (a) Next of (B2) in FIG. 7, when the input of the Next instruction is detected in scene 03 (from two seconds from the reproduction start of the first piece of music to the end of first piece of music), the process transitions to scene 05 (head of the second piece of music) and performs reproduction on the second piece of music that is the next piece of music.

In particular, the reproduction control program (BD-J) 212 acquires the reproduction start position corresponding to the entry mark: EM231 shown in (B2) of FIG. 7 from the playlist file, and initiates the reproduction from the first piece of music. Further, the reproduction control program performs the content reproduction control by referring to the control information corresponding to scenes 02 and 03 of the scenario, detects an input of the Next instruction during the reproduction of scene 03, and then performs transition to the first scene 05 of the second piece of music as the next piece of music reproduction process in accordance with the scenario control information for scene 03. When the transition process is performed, the reproduction control program acquires the position of the entry mark: EM232 shown in (B2) of FIG. 7 corresponding to the start position of scene 05 from the playlist file, and initiates the reproduction from the first scene 05 of the second piece of music.

(b) A case in which an input of a Prev instruction is detected in scene 06 (from two seconds from the reproduction start of the second piece of music to the end of second piece of music)

As shown in (b) Prey of (B2) in FIG. 7, when the input of the Prev instruction is detected in scene 06 (from two seconds from the reproduction start of the second piece of music to the end of second piece of music), the process transitions to scene 05 (head of the second piece of music) and performs reproduction on the second piece of music again that is being currently reproduced.

In particular, the reproduction control program (BD-J) 212 performs the content reproduction control by referring to the control information for scenes 05 and 06 of the scenario to perform reproduction on the second piece of music, detects an input of the Prev instruction during the reproduction of scene 06, and then performs the process of transitioning to the first scene 05 of the second piece of music as the previous piece of music reproduction process according to the scenario control information for scene 06. When the transition process is performed, the reproduction control program acquires the position of the entry mark: EM232 shown in (B2) of FIG. 7 corresponding to the start position of scene 05 from the playlist file, and initiates reproduction from the first scene 05 of the second piece of music.

(c) A case in which an input of a Prev instruction is detected in scene 05 (within two seconds from the reproduction start of the second piece of music)

As shown in (c) Prey of (B2) in FIG. 7, when the input of the Prev instruction is detected in scene 05 (within two seconds from the reproduction start of the second piece of music), the process transitions to scene 02 (first piece of music), and initiates reproduction of the first piece music that is the previous music to the piece of music being currently reproduced (second piece of music).

In particular, the reproduction control program (BD-J) 212 performs the content reproduction control by referring to the control information for scene 05 of the scenario to perform reproduction on the second piece of music, detects an input of the Prev instruction during the reproduction of scene 05, and then performs the process of transitioning to the first scene 02 of the first piece of music as the previous piece of music reproduction process according to the scenario control information for scene 05. When the transition process is performed, the reproduction control program acquires the position of the entry mark: EM231 shown in (B2) of FIG. 7 corresponding to the start position of scene 02 from the playlist file, and initiates reproduction from the first scene 02 of the first piece of music.

(d) A case in which an input of a Next instruction is detected in scene 15 (from two seconds from the reproduction start of the fifth piece of music to the end of fifth piece of music)

As shown in (d) Next of (B2) in FIG. 7, when the input of the Next instruction is detected in scene 15 (from two seconds from the reproduction start of the fifth piece of music to the end of fifth piece of music), the process transitions to scene 02 (first piece of music) and performs reproduction on the first piece of music.

In particular, the reproduction control program (BD-J) 212 performs the content reproduction control by referring to the control information for scene 15 of the scenario to perform reproduction on the fifth piece of music, detects an input of the Next instruction during the reproduction of scene 15, and then performs the process of transitioning to the first scene 02 of the first piece of music as the next piece of music reproduction process according to the scenario control information for scene 15. When the transition process is performed, the reproduction control program acquires the position of the entry mark: EM231 shown in (B2) of FIG. 7 corresponding to the start position of scene 02 from the playlist file, and initiates reproduction from the first scene 02 of the first piece of music.

In addition, FIG. 7 illustrates
(b) Prev instruction, and
(c) Prev instruction.

Any of these Prev instructions is an input for the previous piece of music reproduction instruction while the second piece of music is reproduced. However, the previous piece of music reproduction instructions are differently set.

That is, the case of (b) corresponds to the case in which the input of the Prev instruction is detected in scene 05 after two seconds from the reproduction start of the second piece of music. In this case, the process returns to the first scene (scene 05) of the second piece of music being currently reproduced and performs reproduction.

On the other hand, the case of (c) corresponding to the case in which the input of the Prev instruction is detected in scene 04 within two seconds from the reproduction start of the second piece of music. In this case, the process returns to the first piece of music (scene 02) and performs reproduction.

As described above, the process returns to the piece of music previous to the piece of music being currently reproduced when the Prev instruction is input within a short time (within two seconds) from the reproduction start of any piece of music, and returns to the start position of the piece of music being currently reproduced and resumes reproduction when the Prev instruction is input after two seconds.

This control is one characteristic of the control that is realized in accordance with the scenario description in which the control information for each scene is recorded.

### (3-3. Example of Reproduction Control Process Corresponding to Input Detection of FF Instruction at Time of Repeat Reproduction)

Next, an example of a reproduction control process corresponding to input detection of an FF instruction at the time of repeat reproduction will be described with reference to FIG. 8.

Referring to FIG. 8,
(C1) reproduction control information on a scenario, and
(C2) an example of a reproduction process are illustrated in a similar way to FIGS. 6 and 7.

In addition, for example, (C1) the reproduction control information on a scenario is actually recorded as XML data. The “reproduction control information on scenario” shown in (C1) of FIG. 8 is descriptive text by which the XML data is interpreted and described.

As shown in (C1) of FIG. 8, the reproduction control information corresponding to the input detection of the FF instruction at the time of repeat reproduction includes the following information:

(a) FF input in scene 03 (from 2 seconds from the reproduction start of the first piece of music to an end of the first piece of music): the FF stops at an end of scene 03 (end of the first piece of music), and transitions to scene 02 (head of the first piece of music) and performs reproduction.

The example of reproduction process shown in (C2) of FIG. 8 illustrates the following processes performed on the basis of the scenario mentioned above:

(p) a process in reproduction equipment having a high processing speed; and

(q) a process in reproduction equipment having a low processing speed.

That is, there are various types of reproduction equipment that reproduce the content such as equipment provided with a high-performance CPU and having a high processing speed and equipment provided with an inexpensive CPU having a low processing speed. In these various types of equipment, when the reproduction control program is performed in accordance with the scenario description, for example, a reproduction control timing of the content may deviate.

The example shown in FIG. 8 is a diagram illustrating differences of controls according to the reproduction equipment.

In (p) the process in the reproduction equipment having a high processing speed shown in (C2) of FIG. 8, a process is performed as follows.

The reproduction control program (BD-J) 212 performs reproduction on the first piece of music that is initiated from the entry mark EM241, and performs the content reproduction control by referring to the control information for scene 03 of the scenario. The reproduction control program detects an input of the FF during the reproduction of scene 03 on the basis of the repeat reproduction setting, and initiates the fast-forwarding in accordance with the scenario control information for scene 03. The reproduction control program transitions to the end of the first piece of music (end of scene 03) and performs the process. When the transition is performed, the reproduction control program acquires the position of the link point: LP242 shown in (C2) of FIG. 8 corresponding to the end position of scene 03 from the playlist file, and stops reproduction at the end of the first piece of music. Further, the reproduction control program initiates reproduction from the head position of the first piece of music as the repeat reproduction process control according to the scenario control information for scene 03. When the transition is performed, the reproduction control program acquires the position of the entry mark: EM241 shown in (C2) of FIG. 8 corresponding to the start position of the first scene 02 of the first piece of music from the playlist file, and initiates reproduction from the first scene 02 of the first piece of music.

In (p) the process of the reproduction equipment having the high processing speed, stopping of the FF is correctly performed in the set position of the entry mark and the link point.

On the other hand, in (q) the process of the reproduction equipment having the low processing speed shown in (C2) of FIG. 8, stopping of the FF deviates to be later than the link point: LP242 set at the end of the first piece of music (end of scene 03). This is because the process of the processor or the like has a low processing speed.

However, even in the process having a low processing speed, the deviation does not occur up to the reproduction position of the second piece of music.

For example, when the link point is not set and only the entry mark corresponding to the playitem boundary between pieces of music is used to perform the control, the stop process according to detection of the entry mark 243 shown in (C2) of FIG. 8 is performed at the time of performing the FF in the equipment having a low processing speed, and then the FF stop position may deviate up to the reproduction position of the second piece of music.

However, according to the configuration of the present disclosure, aside from the entry mark corresponding to the playitem boundary between pieces of music, the link point is set to enable the position previous to the link point 242 between pieces of music to be controlled. It is thus possible to prevent the process from unduly advancing up to an unnecessary fast-forward position (a position of a next piece of music) and causing a large processing delay to occur at the time of performing the process such as the FF even in the equipment having a low processing speed.

As described above with reference to FIGS. 6 to 8, the data processing unit of the information processing device of the present disclosure performs reproduction control in accordance with the control information for each scene of the scenario. The data processing unit performs the content reproduction process using the scenario on which the reproduction control information is recorded and the playlist file for music reproduction including designation information on the content to be reproduced.

That is, the data processing unit sequentially switches a plurality of playitems recorded in the playlist for music reproduction, sequentially selects the stream file in which the music content associated with each playitem is stored, and performs continuous reproduction on the music content stored in each stream file.

Each of the playitems recorded in the playlist for music reproduction has designation information corresponding to the stream file in which any one of one music content, one music content and standby screen content, and standby screen content is stored, and the data processing unit sequentially switches the plurality of playitems recorded in the playlist file for music reproduction in accordance with the reproduction control information on the scenario, and performs the reproduction process on the content stored in the stream file associated with each playitem at the time of continuously reproducing the plurality of music contents.

Further, the playlist for music reproduction has playitem information including the designation information on the stream file of which the content is stored as the reproduction target data, an entry mark corresponding to the boundary position of each playitem, and position information corresponding to the link point set within the reproduction section of each playitem. The scenario has control information for each scene that is a content portion divided by the entry mark and the link point.

The data processing unit of the information processing unit performs reproduction control in accordance with the control information for each scene of the scenario, and performs the reproduction control on the content by switching the transition process of the reproduction scene and the control information for each scene of the scenario on the basis of the entry mark and the link point.

The entry mark is set at the start position of at least one piece of music or the start position of the standby screen, and the link point is set at the position at least within the piece of music. The scenes are divided by the entry mark and the link point, and a plurality of scenes are set for each piece of music. The data processing unit performs different controls according to reproduction scenes even in the reproduction period of the same piece of music in accordance with the scenario having the different control information for each scene.

### [4. Other Example of Setting Playlist and Stream File]

Setting the playlist file and the stream file described with reference to FIGS. 5 to 8 is as follows.

Six stream files are set as below:

a stream file of the standby screen (00000.m2ts);

a stream file of the first piece of music (00001.m2ts);

a stream file of the second piece of music (00002.m2ts);

a stream file of the third piece of music (00003.m2ts);

a stream file of the fourth piece of music (00004.m2ts); and

a stream file of the fifth piece of music (00005.m2ts).

In addition, six playitems #0 to #5 are set for one playlist file (PlayList #1) and are associated with the respective stream files as below:

PlayItem #0: stream file of standby screen (00000.m2ts);

PlayItem #1: stream file of first piece of music (00001.m2ts);

PlayItem #2: stream file of second piece of music (00002.m2ts);

PlayItem #3: stream file of third piece of music (00003.m2ts);

PlayItem #4: stream file of fourth piece of music (00004.m2ts); and

PlayItem #5: stream file of fifth piece of music (00005.m2ts).

The playlist file (PlayList #1) has been described as having the configuration including the six playitems #0 to #5 having such a corresponding relation.

Setting of the playlist and the stream file is not limited to the case described above.

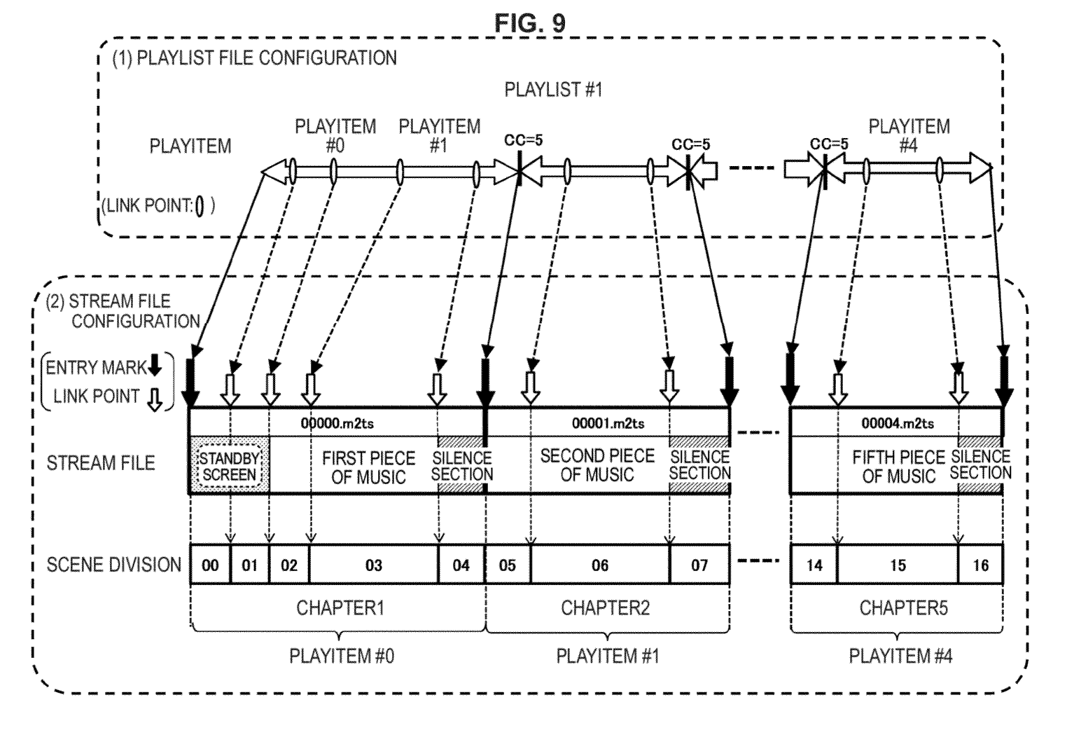

For example, setting shown in FIG. 9 may be used.

Referring to FIG. 9,

(1) a playlist file configuration, and

(2) a stream file configuration are illustrated in a similar way to FIG. 5 described above.

The stream file shown in (2) of FIG. 9 is set to be five stream files as below:

a stream file corresponding to the standby screen and the first piece of music (00000.m2ts);

a stream file corresponding to the second piece of music (00001.m2ts);

a stream file corresponding to the third piece of music (00002.m2ts);

a stream file corresponding to the fourth piece of music (00003.m2ts); and

a stream file corresponding to the fifth piece of music (00004.m2ts).

That is, the standby screen is not separated from the files but included with the first piece of music as one file.

As shown in (1) of FIG. 9, five playitems #0 to #4 are set for one playlist file (PlayList #1), and are associated with the respective stream files as below:

PlayItem #0: a stream file of the standby screen and the first piece of music (00000.m2ts);

PlayItem #1: a stream file of the second piece of music (00001.m2ts);

PlayItem #2: a stream file of the third piece of music (00002.m2ts);

PlayItem #3: a stream file of the fourth piece of music (00003.m2ts); and

PlayItem #4: a stream file of the fifth piece of music (00004.m2ts).

The playlist file (PlayList #1) has five playitems #0 to #4 having such a corresponding relation.

The control information for each scene is described in the scenario even when such stream file and playlist are applied, and various reproduction controls described with reference to FIGS. 6 to 8 are thus realized.

That is, the reproduction control program (BD-J) acquires the control information for each scene described in the scenario and the position information on the entry mark and the link point recorded in the playlist, and the various reproduction controls described with reference to FIGS. 6 to 8 are thus realized.

In addition, in the example described with reference to FIGS. 5 to 8, the standby screen is set at the reproduction position previous to the first piece of music. However, aside from the set position mentioned above, for example, the position of the standby screen may be set at any position such as between pieces of music, after the final piece of music, and so forth.

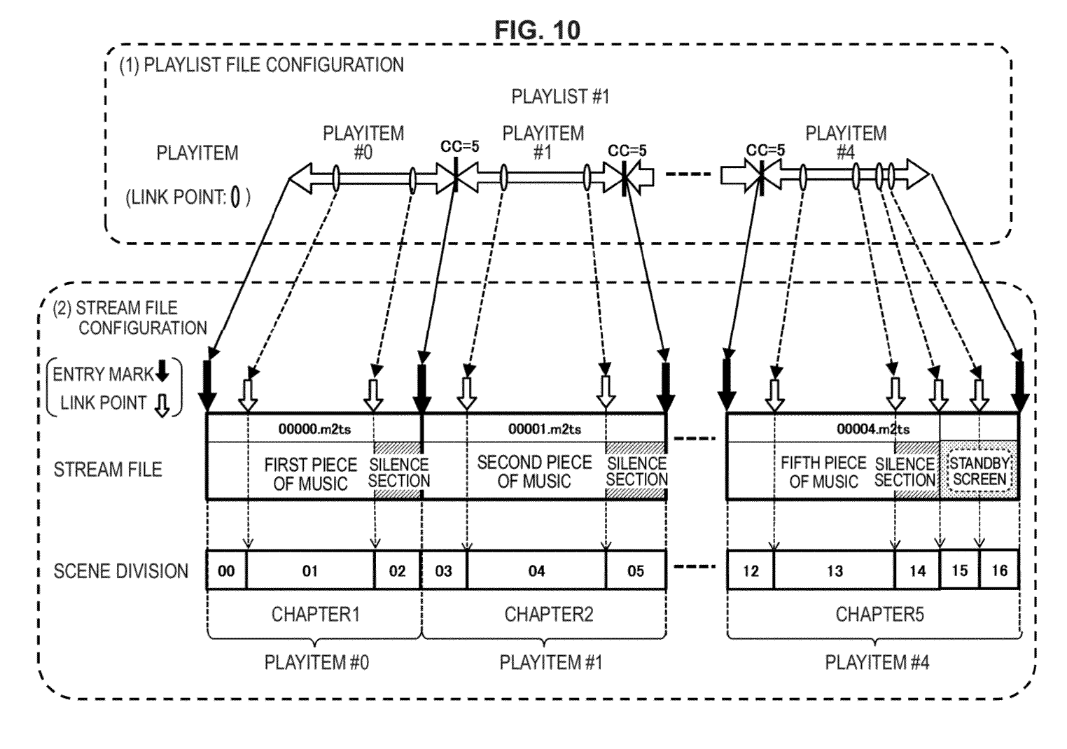

FIG. 10 illustrates an example in which the standby screen is set after the final piece of music.

Referring to FIG. 10,

(1) a playlist file configuration, and

(2) a stream file configuration are illustrated in a similar way to FIG. 5 described above.

The stream file shown in (2) of FIG. 10 is set to be five stream files as below:

a stream file corresponding to the first piece of music (00000.m2ts);

a stream file corresponding to the second piece of music (00001.m2ts);

a stream file corresponding to the third piece of music (00002.m2ts);

a stream file corresponding to the fourth piece of music (00003.m2ts); and

a stream file corresponding to the fifth piece of music and the standby screen (00004.m2ts).

In this case, the standby screen is also not separated from the files but included with the fifth piece of music as one file.

As shown in (1) of FIG. 10, five playitems #0 to #4 are set for one playlist file (PlayList #1) and are associated with the respective stream files as below:

PlayItem #0: a stream file of the first piece of music (00000.m2ts);

PlayItem #1: a stream file of the second piece of music (00001.m2ts);

PlayItem #2: a stream file of the third piece of music (00002.m2ts);

PlayItem #3: a stream file of the fourth piece of music (00003.m2ts); and

PlayItem #4: a stream file of the fifth piece of music and the standby screen (00004.m2ts).

The playlist file (PlayList #1) includes five playitems #0 to #4 having such a corresponding relation.

The control information for each scene is described in the scenario even when such a stream file and playlist are applied, and various reproduction controls described with reference to FIGS. 6 to 8 are thus realized.

That is, the reproduction control program (BD-J) acquires the control information for each scene described in the scenario and the position information on the entry mark and the link point recorded in the playlist, and the various reproduction controls described with reference to FIGS. 6 to 8 are thus realized.

In addition, the standby screen is not limited to the configuration described above with reference to FIG. 2, but may other configurations may be employed.

For example, various settings such as a jacket screen display setting displaying the image corresponding to the jacket of the disc, an operation guide display setting displaying the operation guide, or a menu screen display setting are possible.

### [5. Specific Examples of Scenario Recorded as XML Data and Reproduction Process Examples]

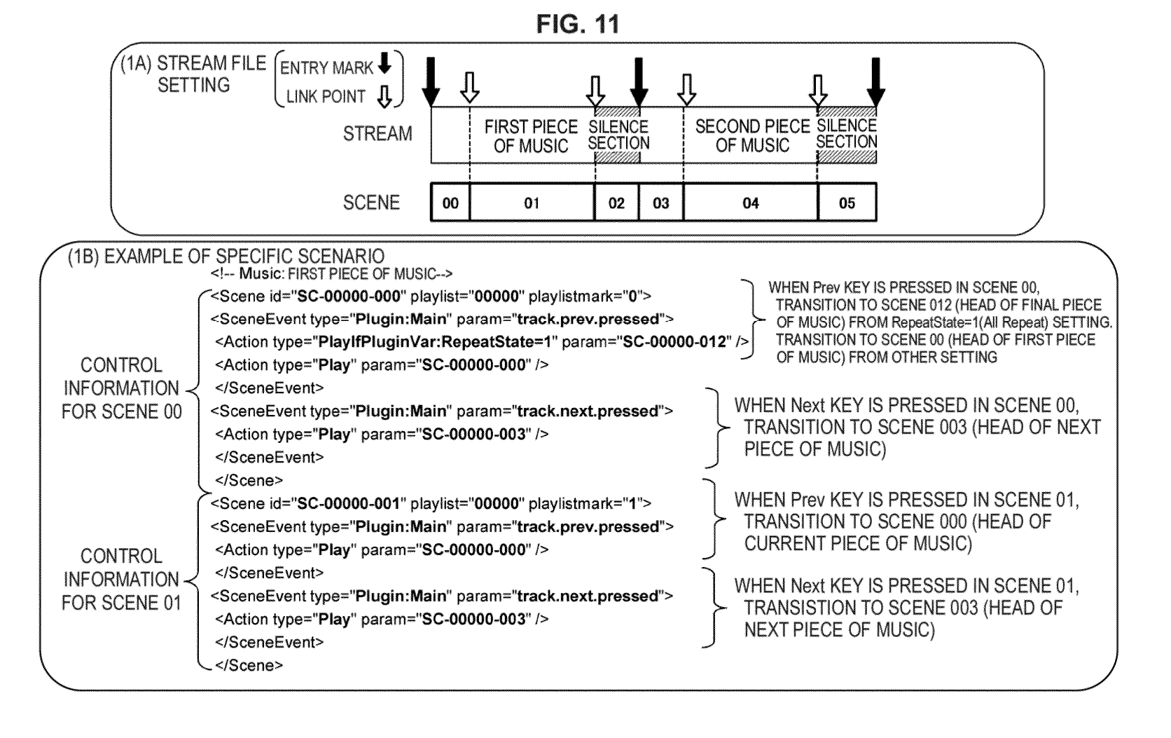

Next, specific examples of the scenario recorded as XML data and reproduction process examples will be described with reference to FIG. 11 and the subsequent drawings.

Referring to FIG. 11, the following data are illustrated:

(1A) a stream file setting; and

(1B) a specific example of the scenario

A portion of the stream file reproduced by one playlist file is illustrated in the stream file shown in (1A). The entry mark is set at the boundary of the playitem set in the playlist file in a similar way to the stream file described above with reference to FIGS. 5 to 10. In addition, the link point is set at the boundary of the scene. The position information on the entry mark and the link point are recorded in the playlist file.

The scenario information shown in (1B) of FIG. 11 illustrates specific examples of the scenario described as the XML data and description information on the specific scenario.

These examples are control information for each scene included in the stream file shown in (1A). Referring to FIG. 11,

control information for scene 00, and

control information for scene 01 are illustrated.

In addition, scene 00 is a reproduction portion of the head portion of the first piece of music (e.g., within two seconds from the head of the first piece of music) and scene 01 is a reproduction portion from two seconds from the head of the first piece of music to the end of the first piece of music as shown in (1A) of FIG. 11.

Hereinafter, specific examples of the XML data included in the scenario and the control process according to the configuration data of each scenario will be described.

### [5-1. Description of Scenario for Scene 00 and Process According to Scenario]

A scenario for scene 00 indicating a former half portion of the specific scenario example shown in (1B) of FIG. 11 will be described first.

(Scenario of former half portion for scene 00)

“<Scene id=”SC-00000-000” playlist=”00000” playlistmark=”0”>
<SceneEvent type=”Plugin:Main” param=”track.prev.pressed”>
<Action type=”PlayIfPluginVar: RepeatState=1”param=”SC-
00000-012”/>
<Action type=”Play” param=”SC-00000-000”/>
</SceneEvent>”

The scenario mentioned above is a scenario describing the control information as below.

“When the Prev instruction is input while scene 00 is reproduced, the repeat reproduction (RepeatState) is set as 1 (repeat all pieces of music) (All Repeat), and the process transitions to scene 12 (head of the last piece of music).

“Otherwise, the process transitions to scene 00 (head of the first piece of music).”

(Scenario of latter half portion for scene 00)

“<SceneEvent type=”Plugin:Main” param=”track.next.pressed”>
<Action type=”Play” param=”SC-00000-003”/>
</SceneEvent>
</Scene>”

The scenario mentioned above is a scenario describing the process control information as below.

“When the Next instruction is input while scene 00 is reproduced, the process transitions to scene 03 (head of the next piece of music).”

### [5-2. Description of Scenario for Scene 01 and Process According to Scenario]

Next, a scenario for scene 01 indicating a latter half portion of the specific scenario example shown in (1B) of FIG. 11 will be described.

(Scenario of former half portion for scene 01)

“<Scene id=”SC-00000-001” playlist=”00000” playlistmark=”1”>
<SceneEvent type=”Plugin:Main” param=”track.prev.pressed”>
<Action type=”Play” param=”SC-00000-000”/>
</SceneEvent>”

The scenario mentioned above is a scenario describing the process control information as below.

“When the Prev instruction is input while scene 01 is reproduced, the process transitions to scene 00 (head of the piece of music being currently reproduced).”

(Scenario of latter half portion for scene 01)

“<SceneEvent type=”Plugin:Main” param=”track.next.pressed”>
<Action type=”Play” param=”SC-00000-003”/>
</SceneEvent>
</Scene>”

The scenario mentioned above is a scenario describing the process control information as below.

“When the Next instruction is input while scene 01 is reproduced, the process transitions to scene 03 (head of the next piece of music).”

### [5-3. Description of Scenario for Scene 02 and Process According to Scenario]

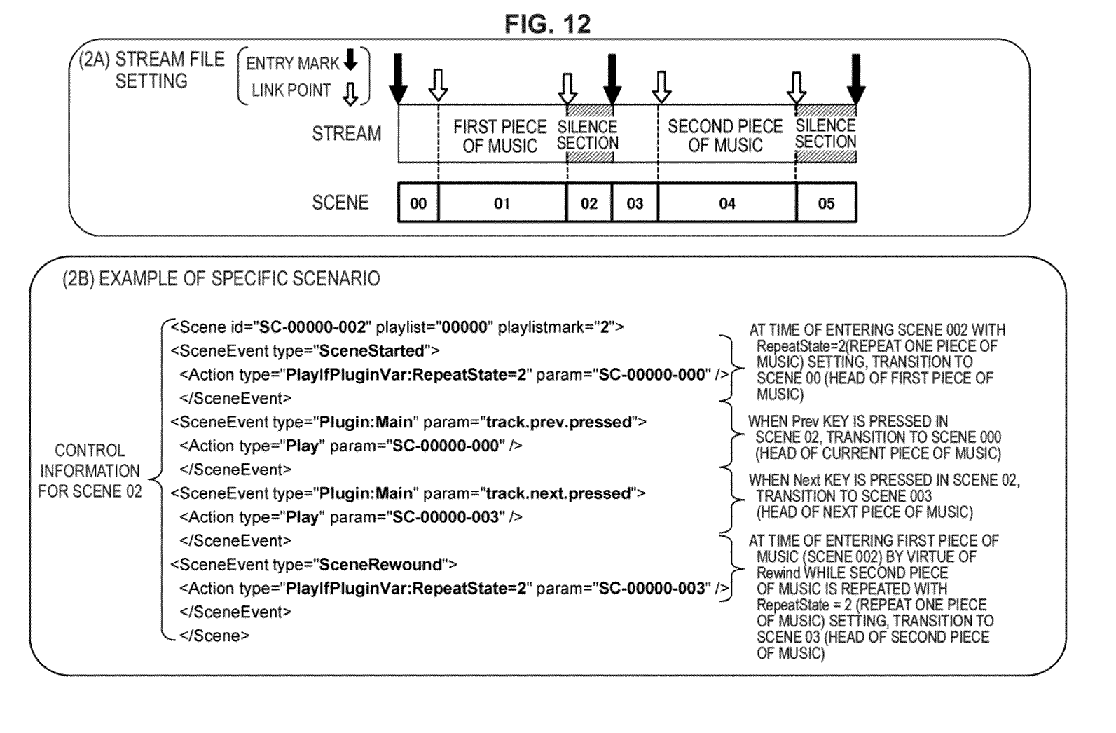

Next, a scenario for scene 02 and a process according to the scenario will be described with reference to FIG. 12.

Referring to FIG. 12, the following data is illustrated in a similar way to FIG. 11:

(2A) a stream file setting; and

(2B) an example of a specific scenario.

The stream file shown in (2A) of FIG. 12 is a similar stream file to that shown in (1A) of FIG. 11, and a portion of the stream file reproduced by one playlist file is illustrated.

The scenario information shown in (2B) of FIG. 12 illustrates a specific example of a scenario described as the XML data and the description information on the specific scenario.

The scenario information is control information for the scene included in the stream file shown in (2A), and the control information for scene 02 is illustrated in FIG. 12.

In addition, scene 02 corresponds to the reproduction portion of the silence portion (a silence section between the first piece of music and the second piece of music) continuing to the end of the first piece of music as shown in (2A) of FIG. 12.

The scenario for scene 02 indicating a specific scenario example shown in (2B) of FIG. 12 will be described.

(Scenario of former half portion for scene 02)

“<Scene id=”SC-00000-002” playlist=”00000” playlistmark=”2”>
<SceneEvent type=”SceneStarted”>
<Action type=”PlayIfPluginVar: RepeatState=2” param=”SC-
00000-000”/>
</SceneEvent>
< SceneEvent type=”Plugin:Main” param=”track.prev.pressed”>
<Action type=”Play” param=”SC-00000-000”/>
</SceneEvent>”

The scenario mentioned above is a scenario describing the process control information as below.

“When the repeat is set as the repeat for one piece of music (RepeatState=2) and the start position (link point) of scene 02 (a silence section continuing to the end of the first piece of music) is detected, the process transitions to the head of the first piece of music (scene 00).

“When the Prev instruction is input during the reproduction of the scene 02 section (a silence section continuing to the end of the first piece of music), the process transitions to scene 00 (head of the first piece of music).”

(Scenario of latter half portion for scene 02))

“< SceneEvent type=”Plugin:Main” param=”track.next.pressed”>
<Action type=”Play” param=”SC-00000-003”/>
</SceneEvent>
<SceneEvent type=”SceneRewound”>
</SceneEvent>
<Action type=”PlayIfPluginVar: RepeatState=2” param=”SC-
00000-003”/>
</SceneEvent>
</Scene>”

The scenario mentioned above is a scenario describing the process control information as below.

“When the Next instruction is input during the reproduction of the scene 02 section (a silence section continuing to the end of the first piece of music), the process transitions to scene 03 (head of the next second piece of music).

“When the repeat is set as repeat for one piece of music (RepeatState=2) and the end position (entry mark) of scene 02 (a silence section continuing to the end of the first piece of music) is detected in accordance with the rewind instruction input, the process transitions to the head of the second piece of music (scene 03).”

### [5-4. Description of Scenario for Scene 12 and Process According to Scenario]

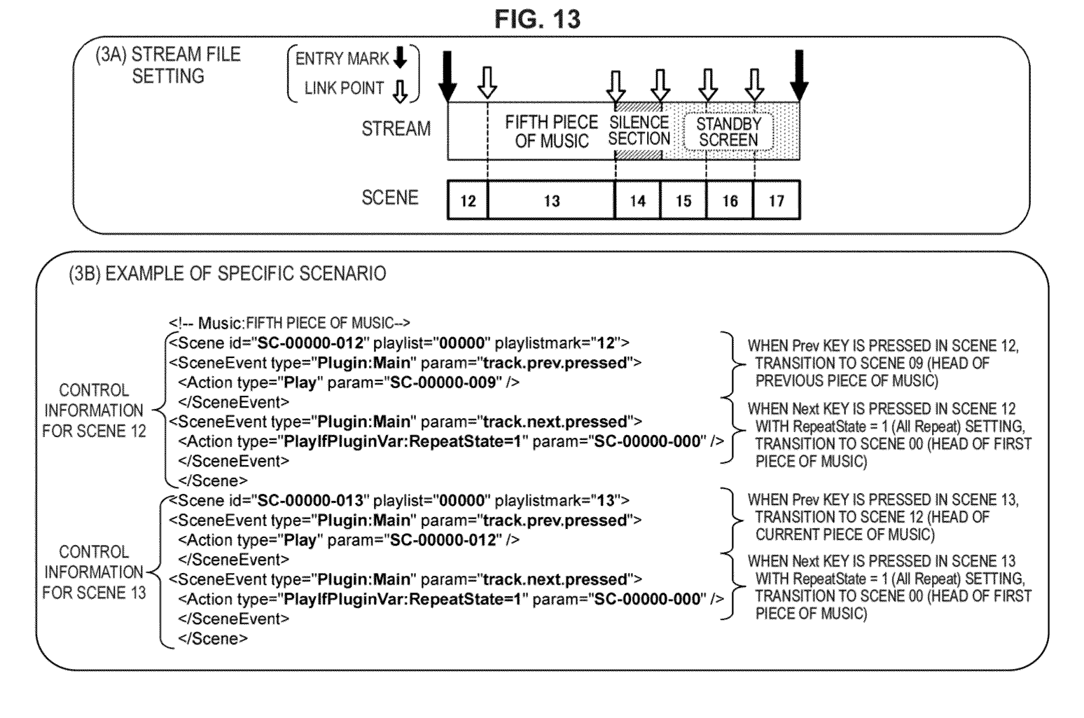

Next, a scenario for scene 12 and a process according to the scenario will be described with reference to FIG. 13.

Referring to FIG. 13, the following data is illustrated in a similar way to FIG. 12:

(3A) a stream file setting; and

(3B) a specific scenario example.

The stream file shown in (3A) of FIG. 13 is a similar stream file to that shown in FIGS. 11 and 12, and a portion of the stream file reproduced by one playlist file is illustrated.

The scenario information shown in (3B) of FIG. 13 illustrates a specific example of a scenario described as the XML data and the description information on the specific scenario.

The scenario information is control information for the scene included in the stream file shown in (3A), and control information for scene 12 and the control information for scene 13 are illustrated in FIG. 13.

In addition, scene 12 corresponds to the reproduction portion of the section within two seconds from the head of the fifth piece of music as shown in (3A) of FIG. 13.

Scene 13 corresponds to the reproduction section from two seconds from the reproduction start of the fifth piece of music to the end of the fifth piece of music.

The scenario for scene 12 indicating the specific scenario example shown in (3B) of FIG. 13 will be described.

(Scenario for scene 12)

“<Scene id=”SC-00000-012” playlist=”00000”
playlistmark=”12”>
<SceneEvent type=”Plugin:Main” param=”track.prev.pressed” >
<Action type=”Play” param=”SC-00000-009”/>
</SceneEvent>
<SceneEvent type=”Plugin:Main” param=”track.next.pressed”>
<Action type=”PlayIfPluginVar: RepeatState=1” param=”SC-
00000-000”/>
</SceneEvent>
</Scene>”

The scenario mentioned above is a scenario describing the process control information as below.

“When the Prev instruction is input during the reproduction of the scene 12 section (head portion of the fifth piece of music), the process transitions to scene 09 (head of the previous piece of music (fourth piece of music)).

“When the repeat is set as repeat for all pieces of music (RepeatState=1) and the Next instruction is input during the reproduction of the scene 12 section (head portion of the fifth piece of music), the process transitions to scene 00 (head of the first piece of music).”

### [5-5. Description of Scenario for Scene 13 and Process According to Scenario]

Next, the scenario for scene 13 and the process according to the scenario will be described with reference to FIG. 13.

As shown in (A) of FIG. 13, scene 13 corresponds to the reproduction section from two seconds from the reproduction start of the fifth piece of music to an end of the fifth piece of music.

(Scenario for scene 13)

“<Scene id=”SC-00000-013” playlist=”00000”
playlistmark=”13”>
<SceneEvent type=”Plugin:Main” param=”track.prev.pressed” >
<Action type=”Play” param=”SC-00000-012”/>
</SceneEvent>
<SceneEvent type=”Plugin:Main” param=”track.next.pressed”>
<Action type=”PlayIfPluginVar: RepeatState=1” param=”SC-
00000-000”/>
</SceneEvent
</Scene>”

The scenario mentioned above is a scenario describing the process control information as below.

“When the Prev instruction is input during the reproduction of the scene 13 section (latter portion other than the head of the fifth piece of music), the process transitions to scene 12 (head of the current piece of music (fifth piece of music)).

“When the repeat is set as repeat for all pieces of music (RepeatState=1) and the Next instruction is input during the reproduction of the scene 13 section (latter portion other than the head of the fifth piece of music), the process transitions to scene 00 (head of the first piece of music).”

### [5-6. Description of Scenario for Scene 14 and Process According to Scenario]

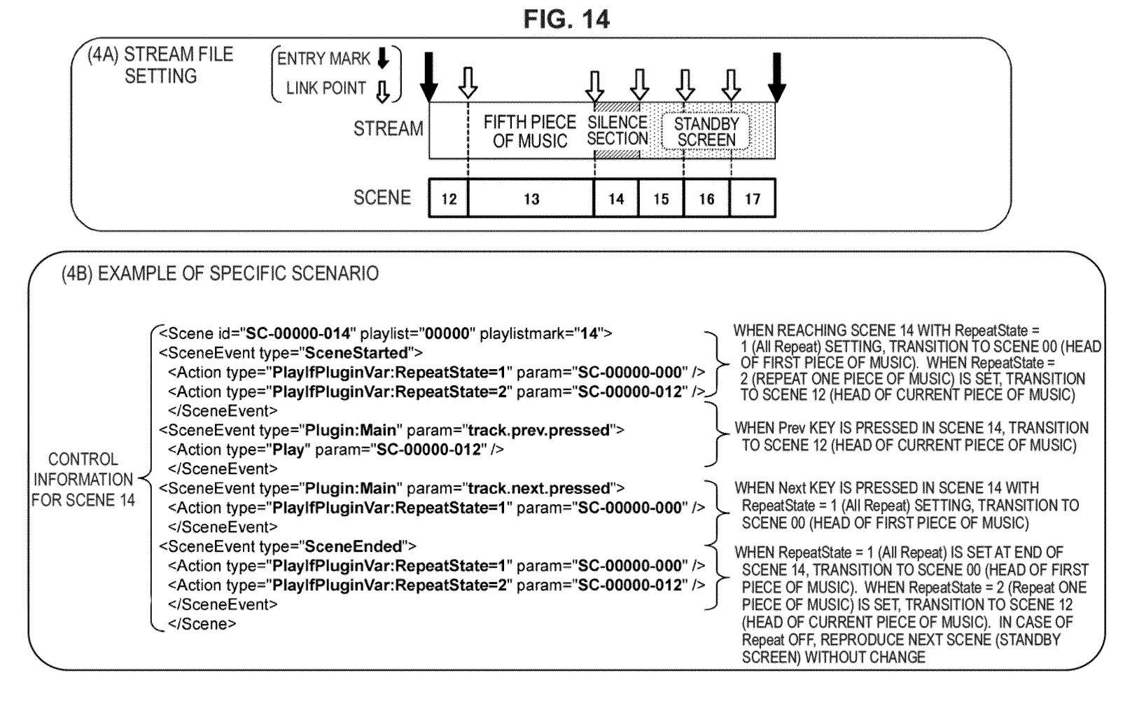

The scenario for scene 14 and the process according to the scenario will be described with reference to FIG. 14.

As shown in (A) of FIG. 14, scene 14 corresponds to the silence section between the end of the fifth piece of music and the standby screen.

(Scenario of the former half portion for scene 14)

“< Scene id=”SC-00000-014” playlist=”00000”
playlistmark=”14”>
<SceneEvent type=”SceneStarted”>
<Action type=”PlayIfPluginVar: RepeatState=1” param=”SC-
00000-000”/>
</SceneEvent>
<Action type=”PlayIfPluginVar: RepeatState=2” param=”SC-
00000-012”/>
</SceneEvent>
<SceneEvent type=”Plugin:Main” param=”track.prev.pressed”>
<Action type=”Play” param=”SC-00000-012”/>
</SceneEvent>”

The scenario mentioned above is a scenario describing the process control information as below.

“When the repeat is set as repeat for all pieces of music (RepeatState=1) and the process reaches scene 14 (a silence section between the end of the fifth piece of music and the standby screen; a link point position), the process transitions to scene 00 (head of the first piece of music).

“When the repeat is set as repeat for one piece of music (RepeatState=2), the process transitions to scene 12 (head of the current piece of music (fifth piece of music)).

“When the Prev instruction is input during the reproduction of the scene 14 section (silence section between the end of the fifth piece of music and the standby screen), the process transitions to scene 12 (head of the current piece of music (fifth piece of music)).”

(Scenario of the latter half portion for scene 14)

“<SceneEvent type=”Plugin:Main” param=”track.next.pressed”>
<Action type=”PlayIfPluginVar: RepeatState=1” param=”SC-
00000-000”/>
</SceneEvent>
<SceneEvent type=”SceneEnded”>
<Action type=”PlayIfPluginVar: RepeatState=1” param=”SC-
00000-000”/>
<Action type=”PlayIfPluginVar: RepeatState=2” param=”SC-
00000-012”/>
</SceneEvent>
</Scene>”

The scenario mentioned above is a scenario describing the process control information as below.

“When the repeat is set as repeat for all pieces of music (RepeatState=1) and the Next instruction is input during the reproduction of the scene 14 section (silence section between the end of the fifth piece of music and the standby screen), the process transitions to scene 00 (head of the first piece of music).

“When the repeat is set as repeat for all pieces of music (RepeatState=1) and the process reaches the last position of scene 14 (a silence section between the end of the fifth piece of music and the standby screen; a link point position), the process transitions to scene 00 (head of the first piece of music).

“When the repeat is set as repeat for one piece of music (RepeatState=2) and the process reaches the last position of scene 14 (a silence section between the end of the fifth piece of music and the standby screen; a link point position), the process transitions to scene 12 (head of the current piece of music (fifth piece of music)).

“When the repeat is set to be off (no repeat (Repeat OFF)) and the process reaches the last position of scene 14 (a silence section between the end of the fifth piece of music and the standby screen; a link point position), the process transitions to reproduction of scene 15 (standby screen).”

### [5-7. Description of Scenarios for Scenes 15 to 17 and Processes According to Scenarios]

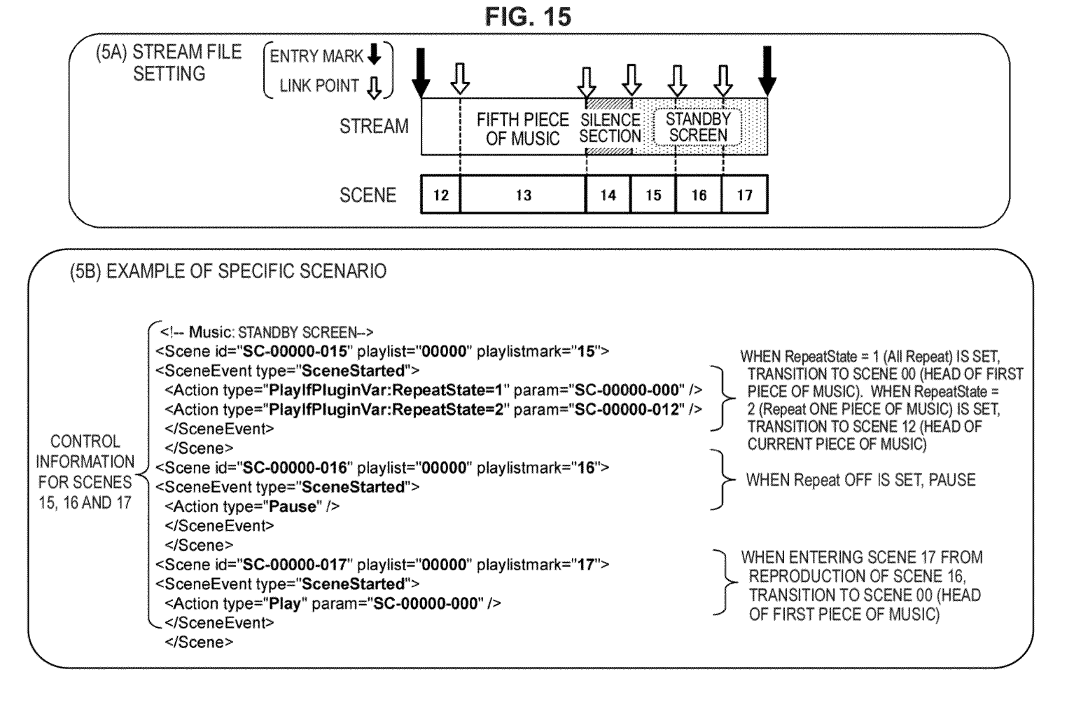

Next, the scenarios for scenes 15 to 17 and the processes according to the scenarios will be described with reference to FIG. 15.

As shown in (A) of FIG. 15, scenes 15 to 17 correspond to the former portion, the middle portion, and the latter portion of the standby screen, respectively.

(Scenario for scene 15)

“<Scene id=”SC-00000-015” playlist=”00000”
playlistmark=”15”>
<SceneEvent type=”SceneStarted”>
<Action type=”PlayIfPluginVar: RepeatState=1” param=”SC-
00000-000”/>
<Action type=”PlayIfPluginVar: RepeatState=2” param=”SC-
00000-012”/>
</SceneEvent>
</Scene>”

The scenario mentioned above is a scenario describing the process control information as below.

“When the repeat is set as repeat for all pieces of music (RepeatState=1) and the process reaches scene 15, the process transitions to scene 00 (head of the first piece of music).

“When the repeat is set as repeat for one piece of music (RepeatState=2), the process transitions to scene 12 (head of the fifth piece of music).”

(Scenario for scene 16)

“<Scene id=”SC-00000-016” playlist=”00000”
playlistmark=”16”>
<SceneEvent type=”SceneStarted”>
<Action type=”Pause”/>
</SceneEvent>
</Scene>”

The scenario mentioned above describes the process control information as below.

“When the repeat is set to be off (no repeat (Repeat OFF) and the process reaches scene 16 (link point position), the process performs the pause (stopping the reproduction (continuous display of the screen (standby screen) being currently reproduced)).”

(Scenario for scene 17)

“< Scene id=”SC-00000-017” playlist=”00000”
playlistmark=”17”>
<SceneEvent type=”SceneStarted”>
<Action type=”Play” param=”SC-00000-000”/>
</SceneEvent>
</Scene>”

The scenario mentioned above describes the process control information as below.

“When the process reaches scene 17 (link point) via scene 16, the process transitions to scene 00 (head of the first piece of music).”

The specific scenarios and the plurality of reproduction control processes according to the scenarios have been described with reference to FIGS. 12 to 15.

As is understood from the description, the scenario is described as control information for each scene.

In particular, the processes according to the inputs of events during the reproduction for each scene section (Prev/Next/FF/REW), the processes upon reaching the first or last position of each scene, and so forth are described.

When the position detection of the events, transition of the reproduction position, or the like is performed, the entry mark and the link point are used as the position information recorded on the playlist mark.

In particular, according to the configuration of the present disclosure, not only the entry mark set between pieces of music but also the link point indicating the finer scene division position is set to discriminate the scene boundaries, and it is thus possible to perform control for each scene and to perform transition for each scene even when the process transitions to the reproduction position.

### [6. Flow of Reproduction Control Process According to Scenario]

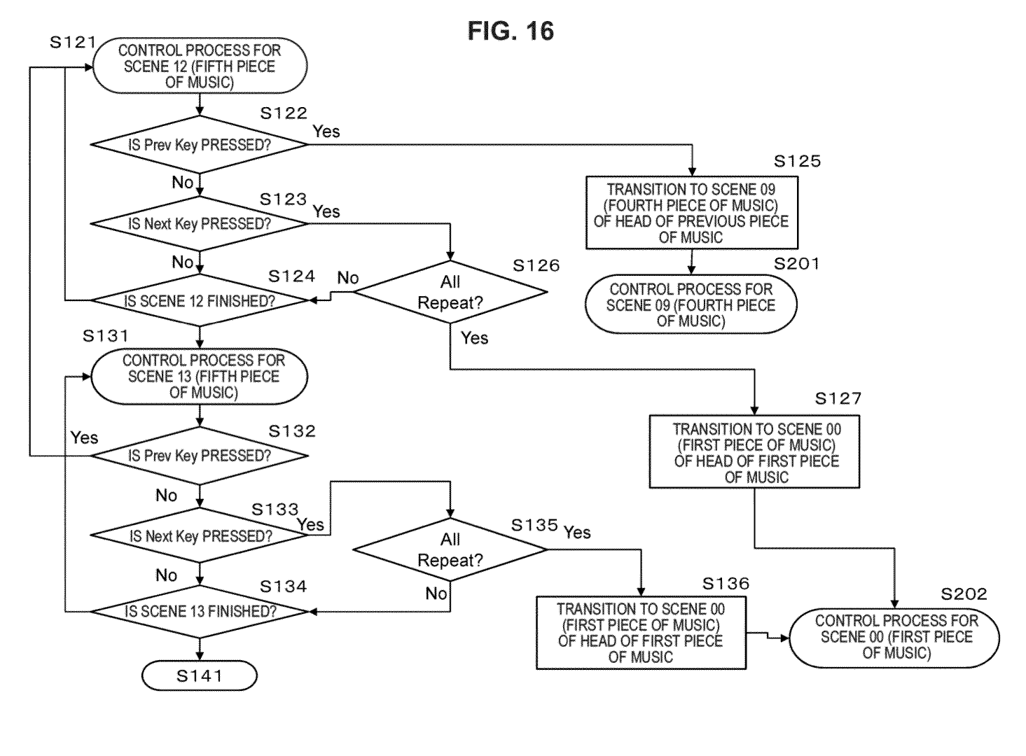

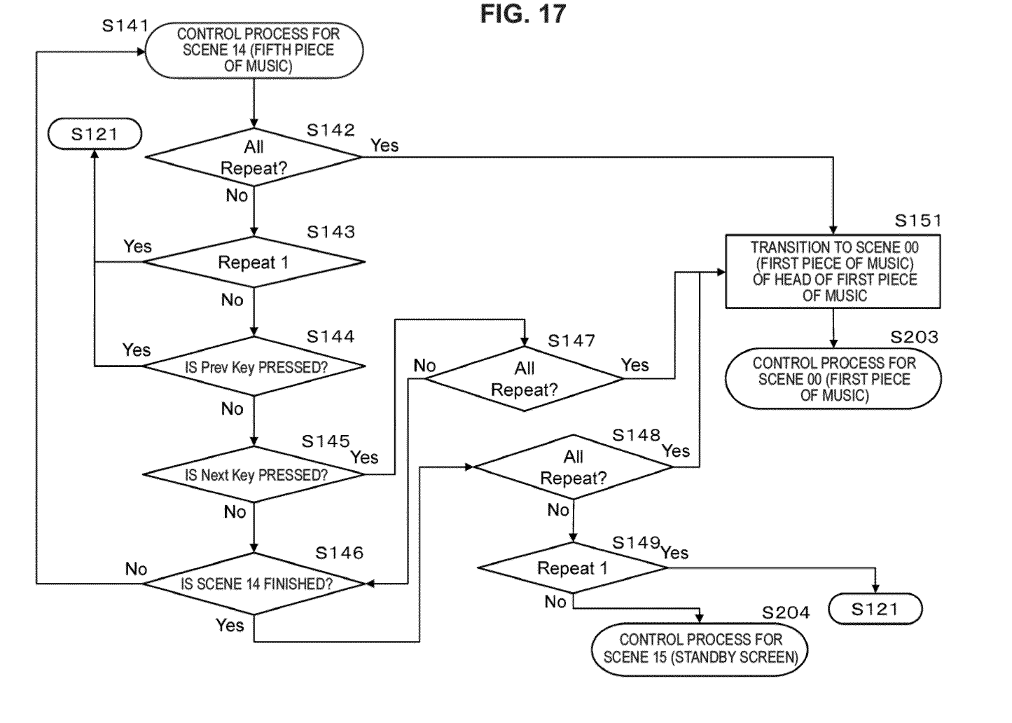

Next, examples of the reproduction control process sequences according to the scenario description will be described with reference to the flowcharts shown in FIGS. 16 and 17.

The flowcharts shown in FIGS. 16 and 17 are flowcharts illustrating the process sequences according to the scenarios for scenes 12 to 14 (from the fifth piece of music to the silence section) described with reference to FIGS. 13 and 14.

The flowcharts shown in FIGS. 16 and 17 are performed under the control of the control unit (data processing unit) of the information processing device that performs the content reproduction.

In step S121 of the flowchart of FIG. 16, when it is detected that the reproduction section is input to scene 12 (head section of the fifth piece of music (e.g., two seconds)), the control for scene 12 is performed in step S121 and the subsequent steps. The control unit of the information processing device (data processing unit) performs the process in accordance with the scenario for scene 12 shown in FIG. 13.

Step S122 is a process of determining whether an input of the Prev instruction is detected during the reproduction of scene 12 as a reproduction section (head of the fifth piece of music (e.g., two seconds)).

When the input of the Prev instruction is detected, the process proceeds to step S125, transitions to scene 09 (head of the previous piece of music (fourth piece of music)), proceeds to step S201, and initiates the reproduction control according to the scenario description for scene 09.

In addition, the transition process is performed by referring to the reproduction position information as the entry mark and the link point recorded in the playlist file.

In step S122, when the input of the Prev instruction is not detected, the process proceeds to step S123, and the process of determining whether an input of the Next instruction is detected is performed.

When the input of the Next instruction is detected, the process proceeds to step S126, and it is determined whether the reproduction process is set as repeat for all pieces of music (RepeatState=1). In addition, the setting is performed in advance by the user input

In step S126, when it is determined that the reproduction process is set as repeat for all pieces of music (RepeatState=1), the process proceeds to step S127, transitions to scene 00 (head of the first piece of music), proceeds to step S202, and initiates the reproduction control according to the scenario description for scene 00.

In addition, the transition process is performed by referring to the reproduction position information as the entry mark and the link point recorded in the playlist file.

On the other hand, when it is determined that the reproduction process is not set as repeat for all pieces of music (RepeatState=1) in step S126, or when the input of the Next instruction is not detected in step S123, the process proceeds to step S124.

In step S124, it is determined whether scene 12 (head of the fifth piece of music) is finished. This determination process is performed on the basis of the link point between scene 12 and scene 13.

In step S124, when it is determined that scene 12 (head of the fifth piece of music) is not finished, the process returns to step S121, and the reproduction control according to the scenario for scene 12 is continuously performed.

On the other hand, in step S124, when it is determined that scene 12 (head of the fifth piece of music) is finished, the process proceeds to step S131, and initiates the reproduction control according to the scenario for scene 13. Determining whether the scene is finished is performed on the basis of the link point between the scenes.

Processes subsequent to step S131 will be described.

When it is determined that the reproduction section is input to scene 13 (a section between two seconds from the reproduction start of the fifth piece of music and an end of the fifth piece of music), the control is performed on scene 13 in steps subsequent to step S131. The control unit (data processing unit) of the information processing device performs the process in accordance with the scenario for scene 13 shown in FIG. 13.

Step S132 is a process of determining whether an input of the Prev instruction is detected during the reproduction of scene 13 as a reproduction section (a section between two seconds from the reproduction start of the fifth piece of music and an end of the fifth piece of music). When the input of the Prev instruction is detected, the process proceeds to step S121, transitions to scene 12 (head of the current piece of music (fifth piece of music)), and initiates the reproduction control according to the scenario description for scene 12.

In addition, the transition process is performed by referring to the reproduction position information as the entry mark and the link point recorded in the playlist file.

In step S132, when the input of the Prev instruction is not detected, the process proceeds to step S133, and it is determined whether an input of the Next instruction is detected.

When the input of the Next instruction is detected, the process proceeds to step S135, and determines whether the reproduction process is set as repeat for all pieces of music (RepeatState=1). In addition, the setting is performed in advance by the user input.

In step S135, when it is determined that the reproduction process is set as repeat for all pieces of music (RepeatState=1), the process proceeds to step S136, transitions to scene 00 (head of the first piece of music), proceeds to step S202, and initiates the reproduction control according to the scenario description for scene 00.

In addition, the transition process is performed by referring to the reproduction position information as the entry mark and the link point recorded in the playlist file.

On the other hand, when it is determined that the reproduction process is not set as repeat for all pieces of music (RepeatState=1) in step S135 or when the input of the Next instruction is not detected in step S133, the process proceeds to step S134.

In step S134, it is determined whether scene 13 (a section between two seconds from the reproduction start of the fifth piece of music and the end of the fifth piece of music) is finished. The determination process is performed on the basis of the link point between scene 13 and scene 14.

In step S134, when it is determined that scene 13 (a section between two seconds from the reproduction start of the fifth piece of music and the end of the fifth piece of music) is not finished, the process returns to step S131, and the reproduction control according to the scenario for scene 13 is continuously performed.

On the other hand, in step S134, when it is determined that scene 13 (a section between two seconds from the reproduction start of the fifth piece of music and the end of the fifth piece of music) is finished, the process proceeds to step S141, and initiates the reproduction control according to the scenario for scene 14.

Determining whether the scene is finished is performed on the basis of the link point between scenes.

Next, the reproduction control process according to the scenario for scene 14 will be described with reference to the flowchart shown in FIG. 17.

In addition, scene 14 corresponds to the silence section from the end of the fifth piece of music to the standby screen as shown in FIG. 14.

When the control unit (data processing unit) of the information processing device detects that the reproduction section is input to scene 14 (silence section between the end of the fifth piece of music and the standby screen), the control unit performs the control for scene 14 in steps subsequent to step S141. The control unit (data processing unit) of the information processing device performs the process in accordance with the scenario for scene 14 shown in FIG. 14.

In step S142, it is determined whether the reproduction process is set as repeat for all pieces of music (RepeatState=1).

When the reproduction process is set as repeat for all pieces of music (RepeatState=1), the process proceeds to step S151, transitions to scene 00 (head of the first piece of music), proceeds to step S203, and initiates the reproduction control according to the scenario description for scene 00.

In addition, the transition process is performed by referring to the reproduction position information as the entry mark and the link point recorded in the playlist file.

When the reproduction process is not set as repeat for all pieces of music (RepeatState=1), the process proceeds to step S143.

In step S143, it is determined whether the reproduction process is set as repeat for one piece of music (RepeatState=2).

When it is determined that the reproduction process is set as repeat for one piece of music (RepeatState=2), the process proceeds to step S121, transitions to scene 12 (head of the fifth piece of music), and initiates the reproduction control according to the scenario description for scene 12.

When the reproduction process is not set as repeat for one piece of music (RepeatState=2), the process proceeds to step S144.

Step S144 is a process of determining whether an input of the Prev instruction is detected during the reproduction of scene 14 (a silence section between the end of the fifth piece of music and the standby screen) as the reproduction section.

When it is detected that the Prev instruction is input, the process proceeds to step S121, transitions to scene (head of the current piece of music (fifth piece of music)), and initiates the reproduction control according to the scenario description for scene 12.

In addition, the transition process is performed by referring to the reproduction position information as the entry mark and the link point recorded in the playlist file.

In step S144, when the input of the Prev instruction is not detected, the process proceeds to step S145, and it is determined whether an input of the Next instruction is detected.

When the input of the Next instruction is detected, the process proceeds to step S147, and it is determined whether the reproduction process is set as repeat for all pieces of music (RepeatState=1). In addition, the setting is performed in advance by the user input.

In step S147, when it is determined that the reproduction process is set as repeat for all pieces of music (RepeatState=1), the process proceeds to step S151, transitions to scene 00 (head of the first piece of music), proceeds to step S203, and initiates the reproduction control according to the scenario description for scene 00.

On the other hand, when it is determined that the reproduction process is not set as repeat for all pieces of music (RepeatState=1) in step S147 or when the input of the Next instruction is not detected in step S145, the process proceeds to step S146.

In step S146, it is determined whether reproduction of scene 14 (a silence section between the end of the fifth piece of music and the standby screen) is finished. The determination process is performed on the basis of the link point between scene 14 and scene 15.

In step S146, when it is determined that the reproduction of scene 14 (a silence section between the end of the fifth piece of music and the standby screen) is not finished, the process returns to step S141, and the reproduction control according to the scenario for scene 14 is continuously performed.

On the other hand, in step S146, when it is determined that the reproduction of scene 14 (a silence section between the end of the fifth piece of music and the standby screen) is finished, the process proceeds to step S148.

In step S148, it is determined whether the reproduction process is set as repeat for all pieces of music (RepeatState=1). When the reproduction process is set as repeat for all pieces of music (RepeatState=1), the process proceeds to step S151, transitions to scene 00 (head of the first piece of music), proceeds to step S203, and initiates the reproduction control according to the scenario description for scene 00.

When the reproduction process is not set as repeat for all pieces of music (RepeatState=1), the process proceeds to step S149.

In step S149, it is determined whether the reproduction process is set as repeat for one piece of music (RepeatState=2).

When the reproduction process is set as repeat for one piece of music (RepeatState=2), the process proceeds to step S121, transitions to scene 12 (head of the fifth piece of music), and initiates the reproduction control according to the scenario description for scene 12.

When the reproduction process is not set as repeat for one piece of music (RepeatState=2), the process proceeds to step S204, and initiates the reproduction control according to the scenario description for the next scene 15 (standby screen).

FIGS. 16 and 17 illustrate content reproduction process sequences using the control information for scenes 12 to 14 that are part of the scenario.

The control information for all scenes is recorded in the scenario, and the control unit (data processing unit) of the information processing device performs the reproduction control by referring to the scenario for each scene.

In addition, the scenario has information as control information for each scene as listed below:

transition destination scene instruction information according to inputs of the Next instruction and the Prev instruction in a reproduction period of each scene;

transition destination scene instruction information according to inputs of the FF and REW in a reproduction period of each scene;

control information according to the repeat reproduction setting for all pieces of music, the repeat reproduction setting for one piece of music, and the no repeat reproduction setting;

control information according to the remote controller operation and the menu screen operation; and

control information on the process of direct transitioning to any scene by the program reproduction or the like.

The data processing unit determines the different transition destination depending on the scene in accordance with the control information for each scene of the scenario.

### [7. Configuration Example of Information Processing Device]

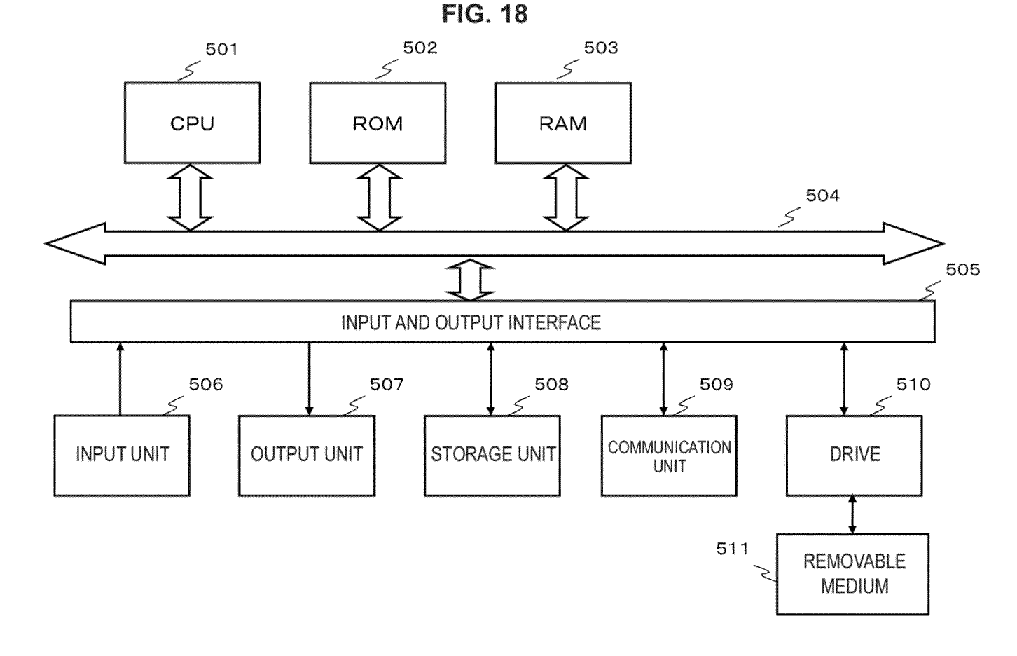

Next, the example of the hardware configuration of the information processing device performing content reproduction according to the scenario will be described with reference to FIG. 18.

A Central Processing Unit (CPU) 501 acts as a data processing unit that executes various processes in accordance with the program stored in a Read Only Memory (ROM) 502 or a storage unit 508. For example, the CPU executes a process of receiving the content, a process of recording the received data on the storage unit 508 or a removable medium 511, a process of reproducing data from the storage unit 508 or the removable medium 511, and so forth. A program or data executed by the CPU 501 is properly stored in a Random Access Memory (RAM) 503. The CPU 501, the ROM 502, and the RAM 503 are interconnected with each other by a bus 504.

The CPU 501 is connected to an input and output interface 505 via the bus 504, and the input and output interface 505 is connected to an input unit 506 such as various switches, a keyboard, a mouse and a microphone, and an output unit 507 such as a display and a speaker. The CPU 501 executes various processes in accordance with the instructions input from the input unit 506, and outputs the processed results to the output unit 507, for example.

For example, the storage unit 508 connected to the input and output interface 505 includes a hard disk, and so forth, and stores various data or programs executed by the CPU 501. The communication unit 509 communicates with an external device via a network such as the Internet and a local area network.

A drive 510 connected to the input and output interface 505 drives the removable medium 511 such as a magnetic disk, an optical disc, a magneto-optical disc, or a semiconductor memory such as a memory card.

Under the control of the CPU 501 as the data processing unit, various data such as content or reproduction control information for the content recorded on the removable medium is acquired, and the acquired data is used to perform the content reproduction process or the like in accordance with the reproduction program executed by the CPU 501 as the data processing unit.

### [8. Sequence of Content Reproduction Process of Information Processing Device]

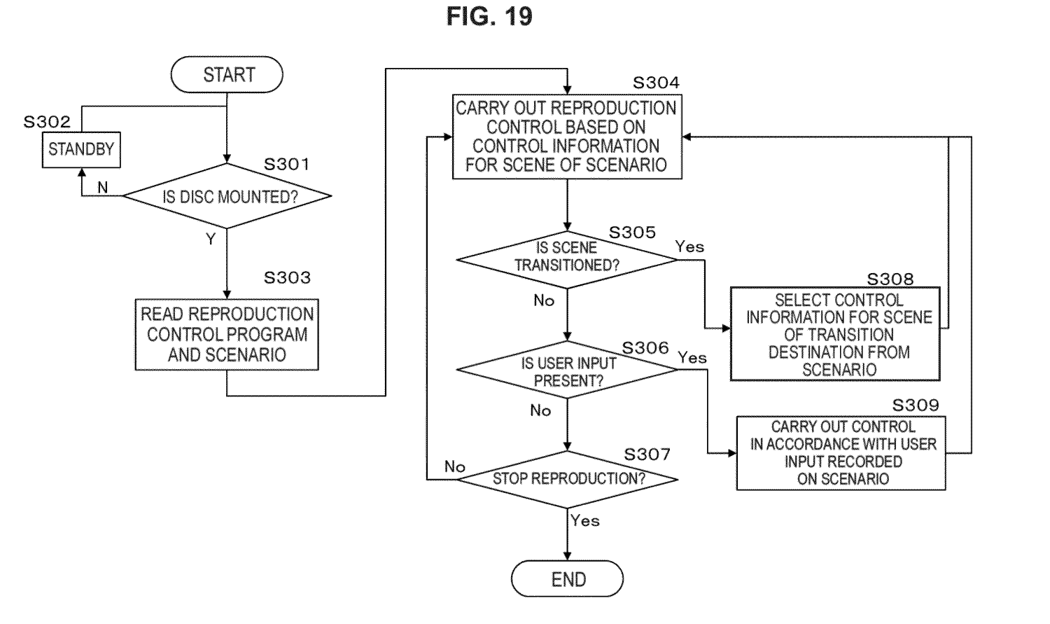

Next, an entire sequence of the content reproduction process executed by the information processing device of the present disclosure will be described with reference to the flowchart of FIG. 19.

In step S301, it is determined whether the disc is mounted on the information processing device. The process includes standing by in step S302 when the disc is not mounted on the information processing device, and proceeding to step S303 when the disc is mounted on the information processing device.

In step S303, the program and the scenario for the content reproduction control are read out from the mounted disc. The program for the content reproduction control is a program such as the BD-J when the mounted disc is the BD, for example. The scenario read out from the disc is a scenario that sets the content reproduction sequences described with reference to FIGS. 6 to 15, for example.

In step S304, the content reproduction is initiated in accordance with the control information for the scene of the scenario. In addition, a definition that a scene reproduced for the first time in accordance with detection of the mounted disc is, for example, an start portion of the first piece of music is recorded in the scenario, and the reproduction is initiated from the first piece of music in accordance with the scenario description.

In addition, designation information on the playitem and the playlist file is recorded in the scenario, the clip information file according to the playlist file and the playitem selected in accordance with the information recorded in the scenario is selected, and the AV stream file on which the music content or the like is stored is acquired to initiate the reproduction.

The reproduction control according to the scenario description for the scene of the first piece of music is then performed. When the reproduction of the first piece of music is initiated from scene 00, the reproduction control according to the control information for the scene 00 of the scenario is initiated.

For example, when the standby screen is set before the first piece of music and the first piece of music has scene 04 and subsequent scenes, the reproduction control according to the control information for the scene 00 of the scenario is initiated.

In step S305, it is determined whether the scene is transitioned. For example, the scene transition is detected at the positions corresponding to the entry mark and the link point recorded in the playlist file described above.

When the scene transition is detected, the control information for the scene of the transition destination is selected from the scenario in step S308, the process returns to step S304, and the reproduction control according to the selected control information for the scene of the transition destination is performed.

In step S306, it is determined whether the user input is present. The user inputs include, for example, the next piece of music reproduction (Next) instruction, the Prev instruction, the FF, the REW, and so forth.

When these user inputs are detected, the control according to the user input recorded in the scenario is performed in step 309. When the scene transition is performed in the process, the control information for the scene of the transition destination is selected, the process returns to step S304, and the reproduction control according to the selected control information for the scene of the transition destination is performed.

In step S307, it is determined whether reproduction of the content that is intended to be reproduced is finished, and the process continues with the reproduction control for the scene of the scenario in step S304 when the reproduction is not finished being performed.

In step S307, the process ends when it is determined that the reproduction is finished.

### [9. Configuration Example of Content Editing Device]

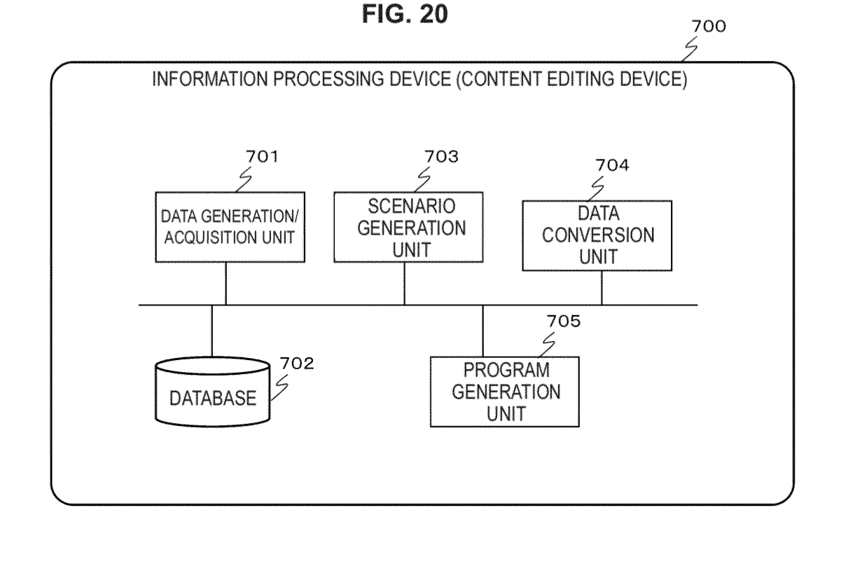

Next, a configuration example of a content editing device will be described with reference to FIG. 20.

FIG. 20 illustrates the configuration example of the content editing device 700. The content editing device 700 generates data for media recording including the scenario.

The data for media recording to be generated includes at least the following:

(a) content for reproduction (audio, a moving image, a still image, text data, and so forth);

(b) a scenario (a scenario in which reproduction control information for the scene is defined.); and

(c) a program for executing the content reproduction according to the scenario (BD-J and so forth).

The content editing device 700 shown in FIG. 20 generates data including the data (a) to (c) mentioned above as recording data. The generated data is, for example, supplied to a disc manufacturing company, a stamper is created, and then discs are manufactured in mass quantities.

The data generation/acquisition unit 701 generates or acquires music content, video content, still image content, text information, and so forth as data for reproduction.

The generated or acquired content is stored in the database 702.

The scenario generation unit 703 generates the scenario that is reproduction sequence definition information for recording content of the recording media.

The data conversion unit 704 performs the process of converting data into data for the recording media.

The program generation unit 705 performs the process of generating the program for the recording media.

As described above, the scenario generated by the scenario generation unit 703 includes the reproduction control information for the scene, and the program generated by the program generation unit 705 is a program that performs the content reproduction process on the basis of the scenario.

For example, when the recording media is the BD, the program generation unit 705 creates the BD-J that is a program for the BD standard.

The data conversion unit 704 creates the data having the hierarchical structure according to the BD format described above with reference to FIGS. 3 and 4, that is, the BD-J as the reproduction control program, the playlist file, the clip file, and so forth.

The data as the recording data is generated in accordance with the media standard mentioned above and then supplied to the disc manufacturing company. In addition, the data is encoded as necessary. When the data is recorded on the media as the encoded data, the information processing device (reproduction device) that is user equipment performing the content reproduction is provided with a decoding key, and the information processing device (a reproduction device) performs the decoding process to perform the reproduction process.

### [10. Summary of Configurations of Present Disclosure]

The present disclosure has been described with reference to specific embodiments thereof. However, it is obvious that modification or substitution in the embodiments may be made by those of ordinary skill in the art without departing from the spirit and scope of the present disclosure. That is, the embodiments of the present disclosure are not described for limitation but for illustration. The following claims are to be taken into consideration to understand the present disclosure.

Additionally, the technology disclosed in the present specification may also be configured as below, for example.

(1) An information processing device including:

a data processing unit configured to perform a process of reproducing content including music content,

wherein the data processing unit performs the content reproduction process using a scenario in which reproduction control information is recorded and a playlist file including designation information on the content to be reproduced,

the playlist file has playitem information including the designation information on a stream file in which the content as reproduction target data is stored, and position information corresponding to an entry mark corresponding to a boundary position between each playitem and a link point set within a reproduction section of each playitem,

the scenario has control information for a scene that is a content portion divided by the entry mark and the link point, and

the data processing unit performs the reproduction control in accordance with the control information for the scene of the scenario, performs transitioning of the scene to be reproduced and switching of the control information for the scene of the scenario on the basis of the entry mark and the link point.

(2) The information processing device according to (1), wherein

the entry mark is set as a start position of at least one piece of music or a start position of a standby screen,

the link point is set as a position at least within a piece of music,

the scene is divided by the entry mark and the link point, and a plurality of scenes are set for one piece of music, and

the data processing unit performs different control depending on the scene to be reproduced even in a reproduction period of the same piece of music in accordance with the scenario having the control information different depending on each scene.

(3) The information processing device according to (1) or (2), wherein

the scenario has instruction information on a transition destination scene according to an input of a next piece reproduction (Next) instruction or a previous piece reproduction (Prey) instruction in a reproduction period of each scene as the control information for each scene, and

the data processing unit performs determination on a different transition destination depending on the scene to which a next piece reproduction (Next) instruction or a previous piece reproduction (Prey) instruction is input even during reproduction of the same piece of music in accordance with the control information for each scene of the scenario.

(4) The information processing device according to any of (1) to (3), wherein

the scenario has instruction information on a transition destination scene according to an input of a fast-forward (FF) instruction or a rewind (REW) instruction in a reproduction period of each scene as the control information for each scene, and

the data processing unit performs determination on a different transition destination depending on the scene to which a fast-forward (FF) instruction or a rewind (REW) instruction are input even during reproduction of the same piece of music in accordance with the control information for each scene of the scenario.

(5) The information processing device according to any of (1) to (4), wherein

the scenario has the control information according to repeat reproduction settings including a repeat reproduction setting for all pieces of music, a repeat reproduction setting for one piece of music, and a no repeat reproduction setting as the control information for each scene, and

the data processing unit performs the reproduction control according to the repeat reproduction setting in accordance with the control information for each scene of the scenario, detects an end of a piece of music to be repeatedly reproduced in the repeat reproduction setting for all pieces of music or the repeat reproduction setting for one piece of music on the basis of the link point of a silence section position that is a scene boundary, and performs control of transitioning to a start position of the repeat reproduction.

(6) The information processing device according to any of (1) to (5), wherein

the scenario has at least any one of remote controller operation information, control information according to menu screen operation information, or control information relating to scene transitioning by virtue of program reproduction as the control information for each scene, and

the data processing unit performs transition destination control in accordance with the control information for each scene of the scenario.

(7) The information processing device according to any of (1) to (6), wherein

the link point is set as a position immediately after start of each piece of music, and the scene is divided by the set position of the link point,

the scenario having the control information for the scene sets a reproduction control mode of a scene immediately after the start of each piece of music and a reproduction control mode of a scene after the scene immediately after the start of each piece of music to be different from each other, and

the data processing unit performs different reproduction control depending on each scene.

(8) The information processing device according to any of (1) to (7), wherein

the link point is set as a boundary position between an end position of each piece of music and a silence section up to a next piece of music, and a scene is divided by the set position of the link point,

the scenario having the control information for the scene sets a reproduction control mode of a scene up to an end of each piece of music and a reproduction control mode of a scene in a silence section immediately after the end of each piece of music to be different from each other, and

the data processing unit performs different reproduction control depending on each scene.

Further, a method of the process performed in the device and the system described above and a program executing the process are also included in the configuration of the present disclosure.

Furthermore, the processing sequence that is explained in the specification can be implemented by hardware, by software and by a configuration that combines hardware and software. In a case where the processing is implemented by software, it is possible to install in memory within a computer that is incorporated into dedicated hardware a program in which the processing sequence is encoded and to execute the program. It is also possible to install a program in a general-purpose computer that is capable of performing various types of processing and to execute the program. For example, the program can be installed in advance in a storage medium. In addition to being installed in a computer from the storage medium, the program can also be received through a network, such as a LAN (local area network) or the Internet, and can be installed in a storage medium such as a hard disk or the like that is built into the computer.

Note that the various types of processing that are described in this specification may not only be performed in a temporal sequence as has been described, but may also be performed in parallel or individually, in accordance with the processing capacity of the device that performs the processing or as necessary. Furthermore, the system in this specification is not limited to being a configuration that logically aggregates a plurality of devices, all of which are contained within the same housing.

As described above, according to the configuration of an embodiment of the present disclosure, a device and method by which the smooth reproduction control on the music content can be performed are realized.

In particular, the content reproduction process is performed using the scenario in which the reproduction control information is recorded and the playlist file including the designation information on the content to be reproduced. The playlist file has PlayItem information including the designation information on the stream file in which the content is stored as the reproduction target data, and position information corresponding to the entry mark for the boundary position of each PlayItem and the link point set within the reproduction section of each PlayItem. The scenario has the control information for the scene that is a content portion divided by the entry mark and the link point. The data processing unit of the information processing device performing the content reproduction performs the reproduction control in accordance with the control information for the scene of the scenario, and performs transitioning of the scene to be reproduced and switching of the control information for the scene of the scenario on the basis of the entry mark and the link point.

According to these configurations, a device and method by which the smooth reproduction control on the music content can be performed are realized.

What is claimed is:

1. An information processing device comprising:
a data processing unit configured to perform a process of reproducing content including music content,
wherein the data processing unit performs the content reproduction process using a scenario in which reproduction control information is recorded and a playlist file including designation information on the content to be reproduced,
the playlist file has playitem information including the designation information on a stream file in which the content as reproduction target data is stored, and position information corresponding to an entry mark corresponding to a boundary position between each playitem and a link point set within a reproduction section of each playitem,
the scenario has control information for a scene that is a content portion divided by the entry mark and the link point, and
the data processing unit performs the reproduction control in accordance with the control information for the scene of the scenario, performs transitioning of the scene to be reproduced and switching of the control information for the scene of the scenario on the basis of the entry mark and the link point.

2. The information processing device according to claim 1, wherein
the entry mark is set as a start position of at least one piece of music or a start position of a standby screen,
the link point is set as a position at least within a piece of music,
the scene is divided by the entry mark and the link point, and a plurality of scenes are set for one piece of music, and
the data processing unit performs different control depending on the scene to be reproduced even in a reproduction period of the same piece of music in accordance with the scenario having the control information different depending on each scene.

3. The information processing device according to claim 1, wherein
the scenario has instruction information on a transition destination scene according to an input of a next piece reproduction (Next) instruction or a previous piece reproduction (Prey) instruction in a reproduction period of each scene as the control information for each scene, and
the data processing unit performs determination on a different transition destination depending on the scene to which a next piece reproduction (Next) instruction or a previous piece reproduction (Prey) instruction is input even during reproduction of the same piece of music in accordance with the control information for each scene of the scenario.

4. The information processing device according to claim 1, wherein
the scenario has instruction information on a transition destination scene according to an input of a fast-forward (FF) instruction or a rewind (REW) instruction in a reproduction period of each scene as the control information for each scene, and
the data processing unit performs determination on a different transition destination depending on the scene to which a fast-forward (FF) instruction or a rewind (REW) instruction are input even during reproduction of the same piece of music in accordance with the control information for each scene of the scenario.

5. The information processing device according to claim 1, wherein
the scenario has the control information according to repeat reproduction settings including a repeat reproduction setting for all pieces of music, a repeat reproduction setting for one piece of music, and a no repeat reproduction setting as the control information for each scene, and
the data processing unit performs the reproduction control according to the repeat reproduction setting in accordance with the control information for each scene of the scenario, detects an end of a piece of music to be repeatedly reproduced in the repeat reproduction setting for all pieces of music or the repeat reproduction setting for one piece of music on the basis of the link point of a silence section position that is a scene boundary, and performs control of transitioning to a start position of the repeat reproduction.

6. The information processing device according to claim 1, wherein
the scenario has at least any one of remote controller operation information, control information according to menu screen operation information, or control information relating to scene transitioning by virtue of program reproduction as the control information for each scene, and
the data processing unit performs transition destination control in accordance with the control information for each scene of the scenario.

7. The information processing device according to claim 1, wherein
the link point is set as a position immediately after start of each piece of music, and the scene is divided by the set position of the link point,
the scenario having the control information for the scene sets a reproduction control mode of a scene immediately after the start of each piece of music and a reproduction control mode of a scene after the scene immediately after the start of each piece of music to be different from each other, and
the data processing unit performs different reproduction control depending on each scene.

8. The information processing device according to claim 1, wherein
the link point is set as a boundary position between an end position of each piece of music and a silence section up to a next piece of music, and a scene is divided by the set position of the link point,
the scenario having the control information for the scene sets a reproduction control mode of a scene up to an end of each piece of music and a reproduction control mode of a scene in a silence section immediately after the end of each piece of music to be different from each other, and
the data processing unit performs different reproduction control depending on each scene.

9. An information recording medium comprising:
a stream file in which content including music content is stored;
a scenario in which reproduction control information on the content is recorded; and
a playlist file including designation information on the content to be reproduced,
wherein the playlist file has playitem information including the designation information on a stream file in which the content as reproduction target data is stored, and position information corresponding to an entry mark corresponding to a boundary position between each playitem and a link point set within a reproduction section of each playitem,
the scenario has control information for a scene that is a content portion divided by the entry mark and the link point, and
the information recording medium allows a reproduction device reproducing the content to perform the reproduction control in accordance with the control information for each scene of the scenario, to perform transitioning of the scene to be reproduced and switching of the control information for the scene of the scenario on the basis of the entry mark and the link point.

10. An information processing method performed by an information processing device having a data processing unit configured to perform a process of reproducing content including music content, the information processing method comprising:
performing, by the data processing unit, the content reproduction process using a scenario in which reproduction control information is recorded and a playlist file including designation information on the content to be reproduced,
wherein the playlist file has playitem information including the designation information on a stream file in which the content as reproduction target data is stored, and position information corresponding to an entry mark corresponding to a boundary position between each playitem and a link point set within a reproduction section of each playitem,
the scenario has control information for a scene that is a content portion divided by the entry mark and the link point, and
the step of performing includes performing the reproduction control in accordance with the control information for each scene of the scenario, transitioning of the scene to be reproduced, and switching of the control information for each scene of the scenario on the basis of the entry mark and the link point.

11. A program causing an information processing device to perform a process of reproducing content, the information processing device having a data processing unit configured to perform the process of reproducing content including music content, the program causing the data processing unit to perform:
performing the content reproduction process using a scenario in which reproduction control information is recorded and a playlist file including designation information on the content to be reproduced,
wherein the playlist file has playitem information including the designation information on a stream file in which the content as reproduction target data is stored, and position information corresponding to an entry mark corresponding to a boundary position between each playitem and a link point set within a reproduction section of each playitem,
the scenario has control information for a scene that is a content portion divided by the entry mark and the link point, and
the step of performing includes performing the reproduction control in accordance with the control information for each scene of the scenario, transitioning of the scene to be reproduced, and switching of the control information for each scene of the scenario on the basis of the entry mark and the link point.
